(19) United States
(12) Patent Application Publication
(10) Pub. No.: US 2025/0196756 A1
(43) Pub. Date: Jun. 19, 2025

(54) SYSTEMS AND METHODS FOR DYNAMIC ATTENUATION OF LIGHT TRANSMISSIBILITY

(71) Applicant: Adeia Guides Inc., San Jose, CA (US)

(72) Inventors: Charles Dasher, Lawrenceville, GA (US); Michael Stevenson, Aldbury (GB); Serhad Doken, Bryn Mawr, PA (US); Jingyu Zhou, Morganville, NJ (US)

(21) Appl. No.: 18/545,434

(22) Filed: Dec. 19, 2023

(51) Int. Cl. B60Q 1/14; F21S 41/135

(52) U.S. Cl. CPC B60Q 1/143; F21S 41/135; B60Q 2300/05; B60Q 2300/122; B60Q 2300/20; B60Q 2300/42

(57) ABSTRACT

Systems and methods are provided herein for dynamically attenuating light transmissibility. For example, the disclosed system detects a light source emanating light that intersects a viewing aperture. The viewing aperture includes a polarizing layer. The system determines a light intensity and a location of the light source corresponding to the detected light. The system determines, based on the determined light source location, a location at which the light intersects the viewing aperture. The system activates the polarizing layer based on the determined light source location. In some embodiments, the polarization layer includes a nanostructure having a plurality of horizontal rods and a plurality of vertical rods arranged in a grid pattern. The nanostructure includes a plurality of pixels, each pixel of the plurality of pixels defined by the intersection of a horizontal rod of the plurality of horizontal rods and a vertical rod of the plurality of vertical rods.

### BACKGROUND

The present disclosure relates to attenuating light transmissibility, and in particular to systems and methods for dynamically attenuating light transmissibility of localized portions of a viewing aperture.

### SUMMARY

Modern cars are being equipped with increasingly bright headlights, which, while theoretically providing the driver with increased visibility, are borderline dangerous to drivers of vehicles travelling in the opposite direction.

When driving at night, the information a driver receives about the road ahead is derived from the light from the driver's own headlights reflecting off the features of the road ahead and back into the driver's eyes (together with reflected light from streetlamps and other light sources when so present). To receive and process this visual information effectively, the driver's eyes adjust to a low light environment, with the pupils dilating to maximize the level at which these light signals fall onto the retina. When an oncoming vehicle approaches with bright headlights, this introduces strong light interference in the driver's field of vision, which dazzles the driver, preventing them from seeing the features of the road ahead, and causing discomfort and visual distortions, which can lead to accidents.

The problem solved by the disclosure is to reduce the level of unwanted light from the headlights of oncoming vehicles entering the driver's field of vision without reducing the level of wanted light entering their field of vision.

Current technology allows the automatic adjustment of vehicle headlights in response to detection of oncoming vehicles. However, this relies on technology in the oncoming vehicle to make the relevant detection and reduce the level of its headlight. For example, an oncoming vehicle's headlights may adjust by reducing parts of the headlight field of projection (for example, matrix LED headlight technology). However, this forces a potentially dazzled driver to be reliant on the level of vehicle detection and headlight technology implemented in an oncoming vehicle, over which they have no control because it is not implemented at their vehicle. Even as such technology increases in prevalence in newer vehicles, older vehicles will remain on the road for years that do not have such technology. A driver investing in anti-dazzle technology in their own vehicle, for example, would obtain no benefit in terms of preventing themselves from being dazzled-only other drivers would benefit. A solution implemented in a driver's own vehicle preventing that driver from being dazzled by the headlights of oncoming vehicles would be an advantageous solution to increasing driver comfort and road safety.

To help overcome deficiencies in the art, the present disclosure implements zone-based dynamic polarization of a windshield to reduce the light transmissibility of localized zones of the windshield without reducing the transmissibility of other zones of the windshield. In an exemplary implementation, a front-facing camera mounted in the vehicle detects unwanted light from, for example, the headlights of oncoming vehicles. In some implementations, a rearward-facing camera detects the position of the driver's eyes, which will vary depending on the driver's height and seat position. In some implementations of the present disclosure, dynamic attenuation of light is accomplished without relying on a polarization filter applied to oncoming vehicle headlights, while in other implementations, a polarizing filter is applied.

In an implementation, the information from cameras is used to determine, for example, through a mapping or transformation, a zone on the windshield that a light ray from a detected incoming light source travelling along the driver's line of sight will intersect the windshield. In response to determining aspects of the incoming light ray, dynamic polarization is applied to the identified zones of the windshield to reduce the intensity of the incoming light rays.

Some implementations of the present disclosure introduce, among other concepts, a novel method which differentiates from existing art in the way in which PCM nanostructures are imprinted onto a metasurface as groups of structures which share a default (unenergized state) orientation (for example, horizontal) and change polarization phase in different orientations at differing voltages. In some implementations, determining the exact location of an occupant's or driver's eyes, their focus, or determining the brightness of oncoming lights is not required to implement certain aspects of the present disclosure. In other implementations, the systems and methods described herein determine certain parameters, including the location of driver's/occupant's eyes, head position, and/or focus. Although aspects may exist in the art associated with determining an occupant's position are discussed and illustrated, the implementations of the present disclosure do not rely on such art. As disclosed in one implementation, the systems and methods described herein may be activated across a pre-determined area of a windshield, in part or in whole based on a simple “switch”.

Implementations of the present disclosure are highly significant to the driver's experience, increasing comfort and safety. The present disclosure allows the solution to be implemented in the driver's vehicle without relying on the level of technology built into other vehicles.

In an exemplary implementation, a first, passive, polarizing layer is introduced across the surface of the windshield (introducing, for example, horizontal polarization). This first layer polarizes incoming light in a particular orientation, for example in the horizontal plane. A second, active (e.g., voltage-activated) polarizing layer is introduced across the surface of the windshield, below or behind the first layer enabling dynamic activation of the polarization in that layer in localized zones. To enable aspects of the present disclosure, the windshield may include a metasurface (a flat, ultra-thin structure patterned with nanostructure). This may be fabricated through manufacturing processes, for example, electron-beam lithography or nano imprint lithography. These nanostructures may be fabricated from a Phase Change Material (PCM) such as vanadium dioxide (VO2) or germanium antimony Telluride (GST). Such a metasurface is laminated between layers of glass or plastic.

The nano structures have different effects on light in different polarization states. In an exemplary implementation, the nanostructures are elongated rods, arranged in a grid pattern. In such an implementation, light polarized parallel to the long axis interacts differently than light polarized perpendicular to the long axis. In an exemplary state, the PCM is in an amorphous phase and the metasurface transmits light that has a certain polarization state, for example, a vertical or horizontal state. The metasurface imprinting of the PCM could be performed so as to create arrays of nanostructures that have default polarization states or stimulated polarization states at differing voltages. For example, the structures may be designed such that their default polarization state is in alignment with the first (or top) layer. In some implementations, such an alignment may further utilize a method of alignment using a light source and Computer Vision equipment to ensure precise alignment of the polarization materials.

In some implementations, when an electrical current is applied to the metasurface, the PCM is induced to undergo a phase change, switching to its crystalline phase. This changes the refractive index of the nanostructures and its polarization state of the light that it transmits. By dynamically applying the stimulus to different areas of the metasurface at differing voltage levels (e.g., as informed by the camera and/or light detection system), the PCM can be stimulated to produce differing polarization states that attenuates the transmissibility by blocking light with the polarization state that contributes to the unwanted glare.

In some implementations, when incoming light sources are detected by front-facing camera(s), a relevant metasurface group to be dynamically polarized is identified using, for example:
1. information from the front-facing camera(s) identifying the position of the light source relative to the camera's field of vision to establish the origin and direction of the incoming light source;
2. information from the rear-facing (e.g., in-cabin) camera identifying the position of the driver's eyes relative to the windshield (including height information) to determine the location of the occupant's head and/or eyes; and
3. a mapping that enables a direct path or line of sight to be inferred between the identified incoming light source and the driver's eye position (e.g., ray tracing).
   Voltage is applied to the windshield areas intersected by the determined direct path or line of sight, reducing the strength of the incoming light rays entering the driver's eyes from the detected light source as they intersect the windshield. Such an implementation provides effective attenuation of unwanted incoming light transmission, without affecting the transmission of desired light relied upon by the driver for driving the vehicle. The presence and orientation (i.e., direction of travel) of vehicles emitting light on a roadway may also be determined using light detection and ranging (“LIDAR”) (also sometimes referred to as laser imaging, detection, and ranging).

In another exemplary implementation, each nanostructure is stimulated at the same voltage level, such that the entire group of PCM structures is activated when a single voltage level is applied to the metasurface. In such an implementation, the system does not necessarily rely on a camera and associated machine learning. The system is activated through a user interface, such as a button, lever, graphical user interface, or other method (e.g., in the same way that one turns on and off the bright lights), the implementation of which will be readily apparent to one skilled in the art. For example, when a driver observes a car approaching and the user anticipates that the oncoming headlights will interfere with visibility, the driver can activate the system using a user-selectable input, for example, a lever or button located in the cabin. Once activated, the system applies voltage, activating a multi-polarized area of the windshield. In some implementations, it is desirable to have polarization orientations based on the area of the windshield in which the nanostructures are located. For example, given the curvature of the windshield at the edges, a particular orientation may optimally attenuate the light transmissibility, and, as such, could include more structures that activate such an orientation in that area.

In another exemplary implementation, the system constructs a three-dimensional rendering of the vehicle's surroundings. For example, as a vehicle's sensors collect data (e.g., via cameras, radar, and/or LIDAR), an image of the vehicle's surroundings is built. Once the front facing camera(s) detect unwanted light (whether from a streetlight, an opposing vehicle, or any other lighting), the dynamic image will be re-rendered to reduce the intensity of this light source at the relevant pixel locations to mitigate unwanted lighting conditions. The image of the vehicle's surroundings is displayed to the driver. For example, the image will be re-rendered on a device (e.g., the vehicle's infotainment system, heads up display, head unit screen, or dashboard) to enable the driver to view the vehicle's surroundings without being affected by the glaring light. In some implementations, such rendering may be only shown if the driver's eyes are detected to be dazzled by the opposing vehicle's lights (via in-cabin monitoring cameras) by switching from the content displayed on the infotainment user interface. The display of the rendering is discontinued when the system determines that the driver is no longer affected by the unwanted light (e.g., when the camera(s) no longer detect the headlights of the opposing vehicle and/or if the driver is not or no longer detected as looking at the head unit display by the inward facing cameras).

Accordingly, systems and methods are described herein for dynamically attenuating light transmissibility. In some embodiments, the disclosed systems and methods detect light emanating from a light source and determine a location of the light source. The disclosed system identifies a location of an occupant of a vehicle. The disclosed system determines a location at which the detected light intersects a viewing aperture of the vehicle based on the determined location of the light source and identified location of the occupant of the vehicle. In some embodiments, the viewing aperture includes a polarizing layer. In some embodiments, the viewing aperture is a windshield of a vehicle. The disclosed system activates the polarizing layer based on the determined location at which the detected light intersects the viewing aperture.

In some embodiments, the polarizing layer includes a nanostructure having a plurality of horizontal rods and a plurality of vertical rods arranged in a grid pattern. The nanostructure includes a plurality of pixels, each of which is defined by the intersection of a horizontal rod of the plurality of horizontal rods and a vertical rod of the plurality of vertical rods. In some embodiments, activating the polarizing layer includes applying a voltage to a plurality of pixels, which causes the nanostructure to undergo a phase change at the location of the plurality of pixels. In some embodiments, the phase change corresponds to the voltage applied to the plurality of pixels.

In some embodiments, the disclosed system further includes receiving data related to the vehicle's surroundings. In some embodiments, such data is received from an imaging sensor. In some embodiments, determining the location of the light source is based on the data received from the imaging sensor. In some embodiments, the disclosed system receives data related to the interior of the vehicle from a second imaging sensor and determining the location of the light source and/or the location of an occupant (including the head and/or eye location) may be further based on data received from the second imaging sensor. In some embodiments, the first imaging sensor is oriented in a direction of travel of the vehicle, and the second imaging sensor is oriented in a direction of the occupant of the vehicle.

In some embodiments of the present disclosure, the polarization layer includes a plurality of zones, each zone having a subset of the plurality of pixels. In such embodiments, activating the polarizing layer further includes applying the voltage to the plurality of pixels corresponding to each zone such that the phase change is uniform across the subset of the plurality of pixels. In other embodiments, the voltage is applied to the plurality of pixels such that the phase change is not uniform (i.e., varies) across the subset of the plurality of pixels. In some embodiments, the size and shape of each zone of the plurality of zones is based on the determined location of the light. In some embodiments, the size and shape of each zone of the plurality of zones is further based on the light intensity. In some embodiments, the disclosed system determines a representation of the vehicle's surroundings based on the data received from the first imaging sensor and the representation of the vehicle's surroundings is displayed to the occupant of the vehicle.

In some embodiments, the disclosed systems and methods detect light that intersects a viewing aperture and determines the location of the source of light and its intensity. In some embodiments, the viewing aperture includes a polarizing layer. The disclosed system determines a light intensity and a location of a light source corresponding to the detected light. The disclosed system determines, based on the determined location of light source, a location at which the light intersects the viewing aperture. The disclosed system activates the polarizing layer based on the determined location of the light source. In some embodiments, the viewing aperture is a windshield of a vehicle.

In some embodiments, the polarization layer includes a nanostructure having a plurality of horizontal rods and a plurality of vertical rods arranged in a grid pattern. The nanostructure includes a plurality of pixels, each pixel of the plurality of pixels defined by the intersection of a horizontal rod of the plurality of horizontal rods and a vertical rod of the plurality of vertical rods. In some embodiments, activating the polarizing layer includes applying a voltage to a plurality of pixels, and applying the voltage to the plurality of pixels causes the nanostructure to undergo a phase change at the location of the plurality of pixels.

In some embodiments, the phase change corresponds to the voltage applied to the plurality of pixels.

In some embodiments, the system for dynamic attenuation receives data related to the vehicle's surroundings and determines the light intensity and the location of the light source based on data received from a camera optionally together with radar and/or LIDAR.

In some embodiments, the system for dynamic attenuation uses location data received from location sensors in oncoming vehicles to determine the location of light sources.

In some embodiments, the system for dynamic attenuation receives data related to the interior of the vehicle from a second camera and its determination of the location of the light source is based on data received from the second camera.

In some embodiments, the first camera is oriented in a direction of travel of the vehicle and the second camera is oriented in the direction of an occupant of the vehicle.

In some embodiments, the viewing aperture includes a plurality of zones, each zone including a subset of the plurality of pixels. Activating the polarizing layer further includes applying the voltage to the plurality of pixels corresponding to each zone such that the phase change is uniform across the subset of the plurality of pixels.

In some embodiments, the size, shape, and location of each zone of the plurality of zones is based on the determined location of the light source.

In some embodiments, the size, shape, and location of each zone of the plurality of zones is further based on the determined light intensity.

In some embodiments, the amount of voltage applied is based on the determined light intensity.

In some embodiments, the system for dynamic attenuation determines a representation of the vehicle's surroundings based in part on data received from the camera. The system for dynamic attenuation displays the representation of the vehicle's surroundings to an occupant of the vehicle.

In another exemplary embodiment, a viewing aperture includes a polarizing layer that includes a nanostructure. The nanostructure includes a plurality of horizontal rods and a plurality of vertical rods arranged in a grid pattern. The nanostructure further includes a plurality of pixels, each pixel of the plurality of pixels defined by the intersection of a horizontal rod of the plurality of horizontal rods and a vertical rod of the plurality of vertical rods. In response to applying a voltage to the plurality of pixels, the nanostructure undergoes a phase change at the location of the plurality of pixels.

In some embodiments, the voltage is applied to the plurality of pixels in response to detecting a light intersecting the viewing aperture. The plurality of pixels corresponds to the location at which the detected light intersects the viewing aperture.

In some embodiments, the viewing aperture is a windshield of a vehicle. In other embodiments, the viewing aperture is a mirror.

In some embodiments, the viewing aperture includes an imaging device, and the light is detected using the imaging device.

In another exemplary embodiment, the system for dynamic attenuation includes a memory configured to store aperture attenuating information. The system also includes control circuitry that determines a light intensity and a location of a light source corresponding to the detected light. In some embodiments, the control circuitry determines a location at which the light intersects the viewing aperture based on the determined location of the light source. In some embodiments, the control circuitry activates the polarizing layer based on the determined location of the light source. In some embodiments, the system also includes input/output circuitry that receives light data corresponding to light intersecting a viewing aperture comprising a polarizing layer from an imaging sensor.

In some embodiments, the viewing aperture includes a windshield of a vehicle.

In some embodiments, the polarization layer includes a nanostructure including a plurality of horizontal rods and a plurality of vertical rods arranged in a grid pattern. The nanostructure includes a plurality of pixels, each pixel of the plurality of pixels defined by the intersection of a horizontal rod of the plurality of horizontal rods and a vertical rod of the plurality of vertical rods. In some embodiments, activating the polarizing layer includes applying a voltage to a plurality of pixels, which causes the nanostructure to undergo a phase change at the location of the plurality of pixels.

In some embodiments, the phase change corresponds to the voltage applied to the plurality of pixels.

Accordingly, using the techniques described herein, light intersecting a viewing aperture is detected and attenuated.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative diagram of a system for dynamic attenuation of light transmissibility, in accordance with embodiments of the disclosure;

FIG. 2 depicts an illustrative diagram of a system for dynamic attenuation of light transmissibility, in accordance with embodiments of the disclosure;

FIG. 3 depicts an illustrative diagram of a system for dynamic attenuation of light transmissibility, in accordance with embodiments of the disclosure;

FIG. 4 depicts an illustrative diagram of a system for dynamic attenuation of light transmissibility, in accordance with embodiments of the disclosure;

FIG. 5 depicts an illustrative flow chart of a system for dynamic attenuation of light transmissibility, in accordance with embodiments of the disclosure;

FIG. 6 depicts an illustrative flow chart of a system for dynamic attenuation of light transmissibility, in accordance with embodiments of the disclosure;

FIG. 7 depicts an illustrative diagram of a system for dynamic attenuation of light transmissibility, in accordance with embodiments of the disclosure;

FIG. 8 depicts an illustrative diagram of a system for dynamic attenuation of light transmissibility, in accordance with embodiments of the disclosure;

FIG. 9 depicts an illustrative diagram of a system for dynamic attenuation of light transmissibility, in accordance with embodiments of the disclosure;

FIG. 10 depicts an illustrative user interface implementing an illustrative system for dynamic attenuation of light transmissibility, in accordance with embodiments of the disclosure;

FIG. 11 depicts an illustrative user interface implementing an illustrative system for dynamic attenuation of light transmissibility, in accordance with embodiments of the disclosure;

FIG. 12 depicts an illustrative user interface implementing an illustrative system for dynamic attenuation of light transmissibility, in accordance with embodiments of the disclosure; and

FIG. 13 depicts an illustrative diagram of a system for dynamic attenuation of light transmissibility, in accordance with embodiments of the disclosure.

### DETAILED DESCRIPTION

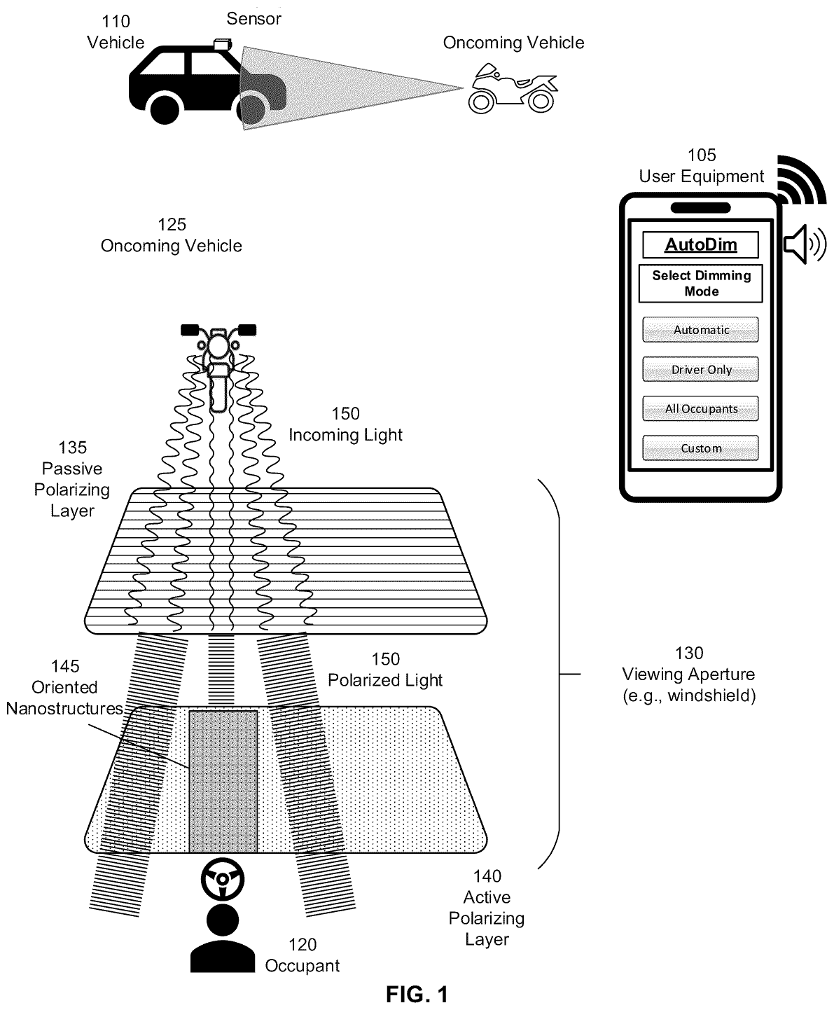

In an exemplary embodiment of the present disclosure and with reference to FIG. 1, vehicle 110 includes imaging sensor 115 and viewing aperture 130 that includes passive polarizing layer 135 and active polarizing layer 140. In such an embodiment, oncoming vehicle 125 projects incoming light 150 in the field of vision of occupant 120. Although oncoming vehicle 125 is illustrated as a motorcycle, any type of oncoming vehicle 125 may be implemented without departing from the contemplated embodiments. As incoming light 150 permeates viewing aperture 130, it passes through passive polarizing layer 135, which polarizes the light in a particular orientation. As illustrated, passive polarizing layer 135 polarizes incoming light 150 in a horizontal direction, resulting in polarized light 150.

Polarized light 150 passes through active polarizing layer 140. In some embodiments, active polarizing layer 150 comprises a metasurface, for example, a flat, ultra-thin structure patterned with nanostructure. In some embodiments, such a nanostructure may include a phase change material (PCM) such as, for example, vanadium dioxide (VO2) or germanium antimony telluride (GST). The metasurface may be manufactured using various techniques, for example, electron-beam lithography or nano imprint lithography, the implementation of which will be readily apparent to one skilled in the art. In some embodiments, the metasurface is laminated between layers (e.g., laminate layer 242) of glass, plastic, polymers, or other suitably transparent materials to implement various embodiments contemplated herein.

In an exemplary embodiment, the nanostructures exhibit various polarization states that may be induced by applying a voltage. For example, the nanostructure comprises elongated rods arranged in a grid pattern (e.g., horizontal and vertical rods). In such an embodiment, light polarized parallel to the long axis interacts differently than light polarized perpendicular to it. In an exemplary default state, for example, when the PCM is in its amorphous state, the metasurface transmits light with a particular polarization state (e.g., vertical or horizontal state). In some embodiments, the metasurface is configured such that the PCM is arranged in arrays of nanostructures that have default polarization states or stimulated polarization states at different voltages. For example, the nanostructures are configured such that their default polarization state is aligned with the passive polarization layer. In such an embodiment, system 100 may include computer vision techniques to align the arrays to ensure precise alignment of the polarization materials.

In an exemplary embodiment, when an electrical current is applied to the metasurface, the PCM is induced to undergo a phase change, causing it to switch to its crystalline phase. Such phase change causes the metasurface to alter the refractive index of the nanostructure and the polarization state of the light that permeates therethrough. In some embodiments, system 100 applies a voltage to the entire active polarizing layer 140. In other embodiments, system 100 applies voltage to less than all of active polarizing layer 140. In such an embodiment, system 100 dynamically applies the voltage to different areas of the metasurface thereby stimulating the PCM to produce differing polarization states in those areas. In other embodiments, system 100 applies varying voltages to differing areas of the metasurface, thereby causing differing polarization states in different areas of the metasurface. In this way, system 100 activates active polarizing layer 140 in different areas and at different amounts.

Polarized light 150 permeates active polarizing layer 140 and system 100 applies voltages to the portion of active polarizing layer 140 that interact with polarized light 150. In such an embodiment, system 100 activates oriented nanostructures 145, thereby preventing polarized light 150 from permeating active polarizing layer 140 in the area bounded by or defined by oriented nanostructures 145. In this way, system 100 dynamically reduces or eliminates incoming light 150 from oncoming vehicle 125 in occupant's 120 field of vision.

In an exemplary embodiment, system 100 includes imaging sensor 115. In such an embodiment and as illustrated, imaging sensor 115 detects incoming light 150 from oncoming vehicle 125. System 100 uses imaging information captured by imaging sensor 115 to determine the locations of viewing aperture 130 at which incoming light 150 intersects viewing aperture 130 along a direct path from the light source to occupant's 120 eyes. Although imaging sensor 115, 215, 216, 715, 915, 917 may be shown and described as a camera (optionally incorporating, or in combination with, a radar detector), any type of imaging sensor may be implemented without departing from the contemplated embodiments. For example, imaging sensor 115 may be embodied by a LIDAR sensor that detects aspects of vehicle's 110 surroundings. Imaging sensor 115 determines the location of a light source of oncoming vehicle 125 (i.e., to determine the location of the source of incoming light 150, to identify the direct path between the position of that location and the position of occupant's 120 eyes along which light rays emanating from the light source of oncoming vehicle 125 enter occupant's 120 eyes, and to identify a location(s) of the aperture at which the identified direct path intersects aperture 130, in two-or three-dimensional space) to enable attenuation of the intensity of incoming light 150 from oncoming vehicle 125. System 100 may detect oncoming vehicle 125 and utilize that information to determine the location of light source of oncoming vehicle 125.

Additionally, although imaging sensor 115 may be illustrated and described as a single sensor of a particular type, any number and/or types, and any combination thereof, of imaging sensors may be implemented without departing from the contemplated embodiments. For example, imaging sensor 115, 215, 216, 715, 915, 917 may include any combination of LIDAR sensor, radar sensor, and video/photographic camera. In such an example, system 100 uses information from the sensors to determine the intensity and location of incoming light 150 from oncoming vehicle 125.

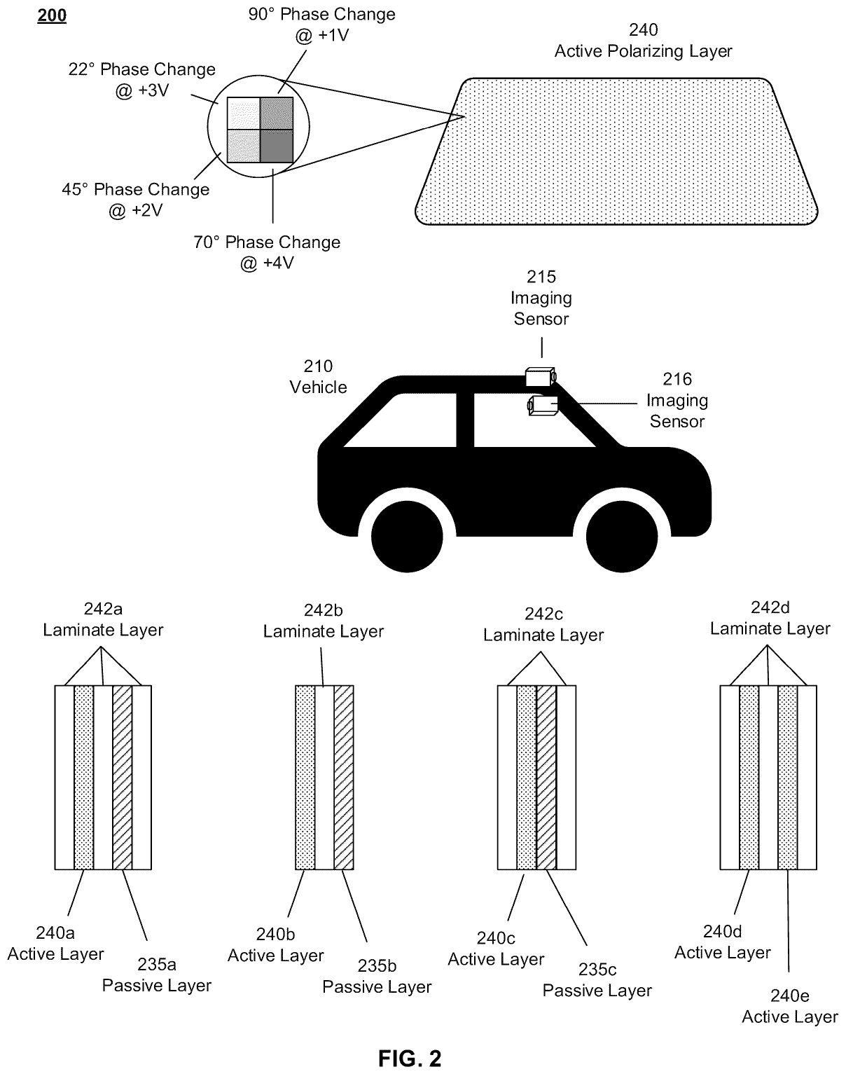

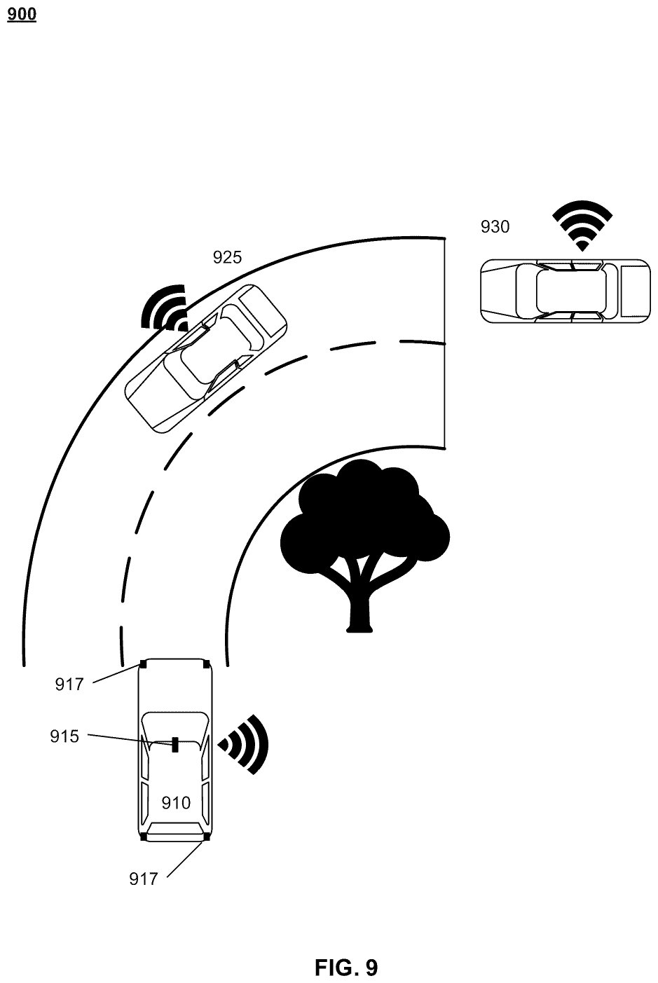

Although imaging sensor 115 may be illustrated and described as installed at the roof of vehicle 110 and oriented in a forward direction, imaging sensors 115, 215, 216, 715, 915, 917 may be installed at any location on vehicle 110 and orientated in a different direction without departing from the contemplated embodiments. For example, imaging sensor 115 may be embodied by multiple imaging sensors installed along the exterior of vehicle 110 and oriented in radial directions (for example, as illustrated and described with respect to FIG. 9). In such an example, imaging sensors 115 may be embodied by LIDAR sensors that, when installed at multiple locations on the vehicle, are able to detect and capture information pertaining to vehicle's 110 surroundings. Additionally, imaging sensors may be embodied by a radar or other sensor that is capable of ranging detected objects. In other embodiments, imaging sensor 115 may be installed within the interior of vehicle 110 and oriented towards the occupants. In such an embodiment, system 100 uses information captured from inward facing imaging sensor 115 to determine the location and orientation of the occupants of vehicle 110. Such configurations are discussed herein, for example, with respect to FIGS. 2 and 9.

Although viewing aperture 130 may be illustrated and described as a windshield of vehicle 110, viewing aperture 130, 730 may be implemented as any type of viewing aperture without departing from the contemplated embodiments. For example, viewing aperture 130 may be embodied by side and/or rear windows of vehicle 110. In other embodiments, viewing aperture 130 may be embodied by glasses, goggles, or other wearable technology that one or more occupants of vehicle 110 wears, for example, occupant 120. Additionally, viewing aperture 130 may be embodied by a window installed on a building or other structure. Viewing aperture 130 may further be embodied by mirrors, e.g., side and/or rearview mirrors of vehicle 110.

Although passive polarizing layer 135 and active polarizing layer 140 may be illustrated and described as being integrated into viewing aperture 130, passive polarizing layer 135 and/or active polarizing layer 140, 240, 340 may be implemented as part of different components. For example, active polarizing layer 140 may be implemented in viewing aperture 130 while passive polarizing layer 135 may be implemented in goggles, glasses, or other wearable technology that one or more occupants of vehicle 110 wear, for example, occupant 120. Additionally, although a single passive polarizing layer 135 and a single active polarizing layer 140 may be illustrated and described, any number of passive polarizing layer 135 and/or active polarizing layers 140 may be implemented, including zero, without departing from the contemplated embodiments. For example, in some embodiments, system 100 includes two active polarizing layers 140 and zero passive polarizing layers 135 (for example, as discussed with respect to FIG. 2). In such an embodiment, a first active polarizing layer orients incoming light 150 in a particular direction while a second active polarizing layer 140 polarizes polarized light 150 in another direction, thereby dynamically attenuating incoming light 150.

In some embodiments, passive polarizing layer 135 and active polarizing layer 140 are added to an existing viewing aperture 130. In such an embodiment, passive polarizing layer 135 may be added to the exterior of an existing windshield and active polarizing layer 140 may be added to the interior of that same windshield. In this way, techniques of the present disclosure may be implemented with existing viewing apertures, i.e., existing vehicles.

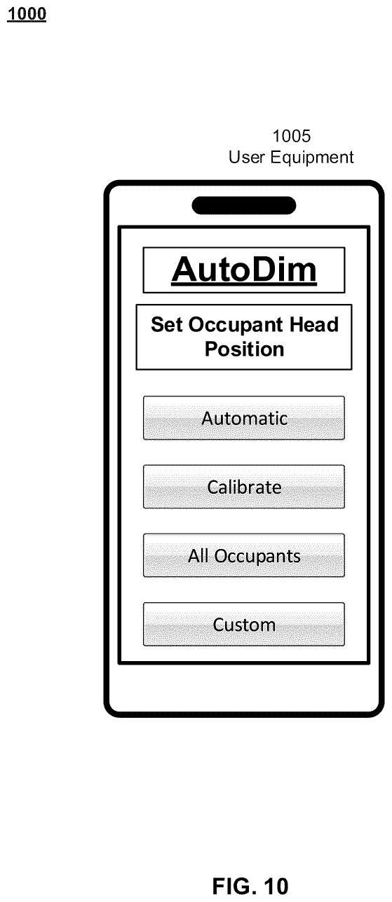

In another exemplary embodiment, system 100 includes user equipment 105. In some embodiments, user equipment 105 is used as a user interface device for, e.g., occupant 120, to implement various features of the present disclosure. For example, user equipment 105 includes user selectable elements that, when selected, implements various modes. For example, a user can implement dynamic attenuation of one or more viewing apertures for a single occupant of the vehicle, e.g., the driver. Alternatively, a user can implement dynamic attenuation of one or more viewing apertures for all occupants of the vehicle, e.g., the driver and all passengers. In some embodiments, user equipment 105 includes an “automatic” selectable option that, when selected, allows system 100 to determine which occupants to consider when dynamically attenuating one or more viewing apertures. Additional techniques and functionality relating to user equipment are discussed further herein, for example, as illustrated and described with respect to FIGS. 10-13.

In another exemplary embodiment of the present disclosure and with reference to FIG. 2, active polarizing layer 240 comprises a plurality of pixels defined by the intersection of rods, for example, the horizontal and (activated) perpendicular (or other) rods meet. Although referred to as “pixel” herein, the location may also be referred to as “incidence point” or “s-point” herein. In some embodiments, system 200 applies current (or voltage) to active layer 240, inducing a phase change in the active layer corresponding to the applied voltage. For example and as illustrated, the PCM undergoes a phase change of 90°, 45°, 22°, and 70° when 1, 2, 3, or 4 volts are applied, respectively. Although certain phase changes are illustrated and described as being induced in response to applying certain voltages, any phase change corresponding to any voltage may be implemented without departing from the contemplated embodiments. Additional embodiments of active polarizing layer 240 are discussed herein, for example, active polarizing layer 140, 340.

In some embodiments, vehicle 210 includes imaging sensor 215. As illustrated, imaging sensor 215 is located towards the front of vehicle 210 and oriented in the direction of travel, i.e., forward. Although imaging sensor 215 is illustrated and described as being located towards the front of vehicle 210 and oriented in a particular direction, imaging sensor 215 can be located anywhere on vehicle 210 and oriented in a different direction, without departing from the contemplated embodiments. Imaging sensor 215 can be embodied by any type of imaging or photo detector, without departing from the contemplated embodiments. For example, imaging sensor 215 may be embodied by a photo or video camera (optionally incorporating or in combination with a radar sensor). Alternatively, imaging sensor 215 can be embodied by a LIDAR sensor. Additionally, although a single imaging sensor 215 may be illustrated and described, any number of imaging sensors 215 can be implemented in combination without departing from the contemplated embodiments. In some embodiments, imaging sensor 215 is a dedicated sensor to implement the various techniques described herein. In other embodiments, imaging sensor 215 may be preexisting sensors of vehicle 210, for example, those used in conjunction with parking or other driving features (e.g., active cruise control, autonomous or semi-autonomous driving features). Additional embodiments of imaging sensor 215 are discussed herein, for example, imaging sensor 115, 216, 715, 915, 917.

In some embodiments, vehicle 210 includes imaging sensor 216. As illustrated, imaging sensor 216 is located in the interior of vehicle 210, located towards the front of vehicle 210, and oriented opposite the direction of travel, i.e., rearward. Although imaging sensor 216 is illustrated and described as being located towards the front of vehicle 210 and oriented in a particular direction, imaging sensor 216 can be located anywhere on or within vehicle 210 and oriented in a different direction, without departing from the contemplated embodiments. Imaging sensor 216 can be embodied by any type of imaging or photo detector, without departing from the contemplated embodiments. For example, imaging sensor 216 may be embodied by a photo or video camera. Alternatively, imaging sensor 216 can be embodied by a LIDAR sensor. Additionally, although a single imaging sensor 216 may be illustrated and described, any number of imaging sensors 216 can be implemented without departing from the contemplated embodiments (for example, any number of imaging sensors 216 of the same type, or any number of different types of imaging sensors 216).

In an exemplary embodiment, system 200 receives information from imaging sensor 215 and determines the location and intensity of incoming light source(s) (e.g., incoming light 150). Using the determined information, system 200 determines the pixels or groups of pixels (e.g., zones) that correspond to the location(s) on the aperture disposed on a direct path between the position of a detected light source and the position of an occupant's eye (or eyes), such that rays travelling along said direct path (or paths) from said light source to said occupant's eye (or eyes) would intersect the aperture at that location (or those locations). System 200 thus determines the corresponding zone(s) of active layer 240. Once determined, system 200 applies a voltage to active layer 240 to induce a phase change of the pixels in the determined zone(s). Additionally, system 200 applies the voltage based on the intensity of the incoming light. For example, the higher the intensity of the incoming light, system 200 applies a voltage that corresponds to phase change corresponding to a polarization that results in less light passing through the viewing aperture. In this way, system 200 determines the location of the source and the intensity of incoming light and, in response, dynamically activates active polarizing layer 240 in a relevant zone to attenuate the viewing aperture (e.g., viewing aperture 130) to mitigate the intensity of the incoming light. In some embodiments, the described techniques can be performed simultaneously for i) multiple different identified light sources affecting a single occupant, thus determining and acting upon the direct paths between each of the detected light sources and each of the eyes of the occupant, ii) a single identified light source affecting multiple occupants, thus detecting and acting upon the direct paths between the light source and each of the occupants' eyes, and/or iii) multiple different identified light sources affecting multiple occupants, thus detecting and acting upon a larger number of direct paths. Furthermore, in each case, system 200 may, rather than identifying separate paths between a light source and each of an occupant's eyes, use a single point on the occupant's head, and may thus identify a single direct path from a given light source to a given occupant. In such an embodiment, system 200 may potentially apply voltage to an enlarged area of the aperture to compensate for the uncertainty over the precise position of the occupant's eyes from that single point. In some embodiments the intensity detection above may be omitted, and in such embodiments varying the attenuation based on the detected intensity would also be omitted.

In some embodiments, system 200 determines the head and/or eye position of one or more occupants of vehicle 210. For example, system 200 receives information from imaging sensor 216 to determine the head and/or eye location of one or more occupants of vehicle 210. In such an example, system 200 receives information from imaging sensor 216. System 200 applies various techniques, for example, computer vision, to determine the location of one or more occupants of vehicle 210. Additionally, system 200 may implement techniques to determine the eye or head position and/or orientation of one or more occupants of vehicle 210. For example, system 200 applies an eye and/or head tracking technique that determines the location and orientation of the eyes and/or head of one or more occupants of vehicle 210. In this way, system 200 determines or approximates the location and orientation of the eyes of the occupants of vehicle 210 to dynamically attenuate the incoming light directed at the one or more occupants.

While certain embodiments may be illustrated and discussed as using an imaging sensor to determine the location and orientation of one or more occupants of vehicle 210 (e.g., imaging sensor 216), system 200 need not precisely determine the location and/or orientation of the occupants in a vehicle 210 to effectively implement the techniques and features of the present disclosure. For example, system 200 estimates the locations of occupants and their physical orientation. In such an example, system 200 may receive information relating to the presence of occupants of vehicle 210. In such an example, system 200 determines the presence of occupants from, for example, seat belts or other sensors used to, e.g., implement safety features of vehicle 210 (e.g., airbags, restraint systems). System 200 may retrieve stored height information for occupants of a vehicle. System 200 may, for example, use image recognition to identify occupants and apply the correct height information for an occupant, by matching the appearance of an occupant to an entry in a stored database containing image data of individuals together with user-entered height information for each of the individuals. In systems where different keys are assigned to different drivers, and where the system stores a user profile corresponding to each assigned key containing stored user-entered height information for the driver to whom the key has been assigned, system 200 may retrieve, from the user profile, height information for the driver that corresponds to the key being used. In cases where height information for an occupant is used, system 200 may also process the current seat position settings for the occupant to make a better determination of eye and/or head position. Alternatively, the system may estimate the head position of vehicle occupants by, for example, receiving user input specifying the number of occupants, the height and/or head orientation/location of occupants, and the location of occupants. In such an example, a user can input such parameters in a user equipment device, e.g., user equipment 105, 1005, 1105, 1205, 1305, including a mobile device or infotainment system of vehicle 210. In some embodiments, system 200 estimates the head location of one or more occupants of vehicle 210. In such an example, system 200 uses a pre-programmed default height for occupants, based on an average height of an adult, wherever it is identified that a seat is occupied. System 200 may be configured to apply voltage to larger zones of the aperture on account of the lack of precision about the location of occupant's eyes.

In another exemplary embodiment of the present disclosure, the viewing aperture (e.g., viewing aperture 130) includes active layers, passive layers, and/or laminate layers. Although a certain number and/or configuration of active layers, passive layers, and laminate layers may be illustrated and described, any number of active layers, passive layers, and/or laminate layers may be used (including zero) without departing from the contemplated embodiments.

In an exemplary embodiment, active layer 240a and passive layer 235a is implemented along with a laminate layer 242a in between. As illustrated, laminate layers 242a also encase active layer 240a and passive layer 235a. In such a configuration, laminate layers 242a additionally serve to protect active layer 240a and passive layer 235a. In another exemplary embodiment, active layer 240b and passive layer 235b are separated by laminate layer 242b without exterior laminate layers. In another exemplary embodiment, active layer 240c and passive layer 235c are positioned next to each other, which are both encased by laminate layer 242c. In some embodiments, system 200 comprises two active layers 240d and 240e, which are separated by, and encased within, laminate layer 242d. In such an embodiment, system 200 implements two active layers and zero passive layers.

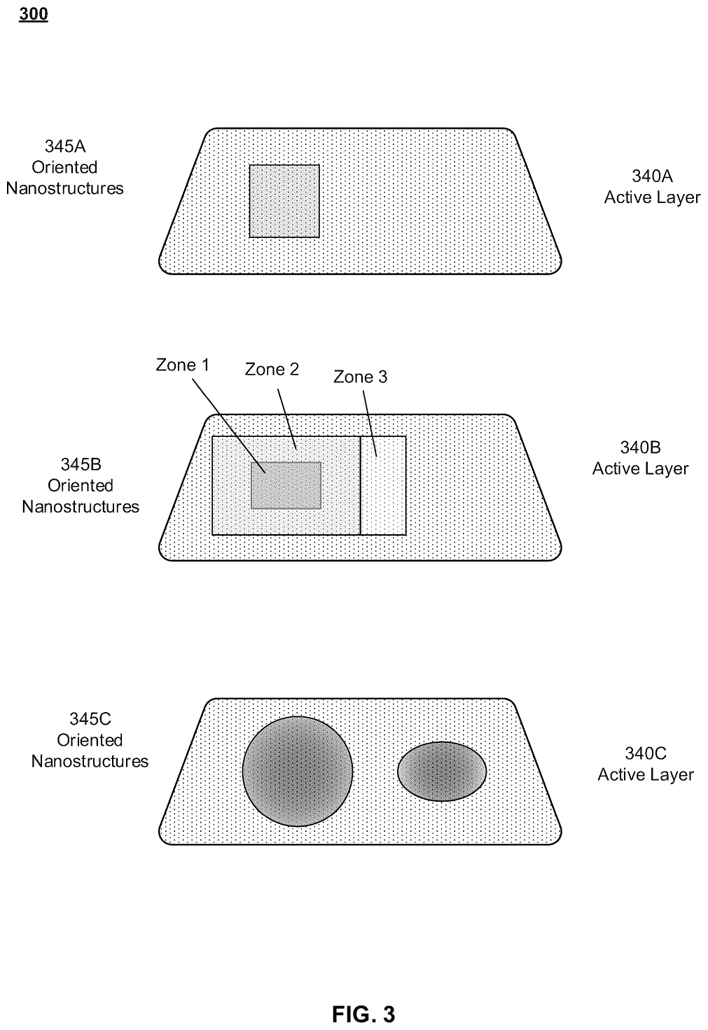

In another exemplary embodiment of the present disclosure and with reference to FIG. 3, system 300 supplies varying voltages to the active layer(s) (e.g., active polarizing layer 140, 240, 340) at various locations, which orients nanostructures in those locations. In some embodiments, system 300 applies uniform voltages to pixels contained in particular areas, thereby creating various zones of attenuations. In such an example, system 300 applies voltages to the pixels of active layer 340A corresponding to a particular area, resulting in oriented nanostructures 345A in that area. As a result, the zone (or zones) of the viewing aperture corresponding to the area of oriented nanostructures 345A is attenuated while the remainder of active layer 340A is unattenuated.

Although a particular area of active layer 340A is illustrated as having a uniform attenuation, various areas of the viewing aperture may be attenuated at differing attenuation levels, without departing from the contemplated embodiments. For example, system 300 applies three different voltages to pixels of active layer 340B at three different zones, resulting in three different levels of attenuation. As illustrated, oriented nanostructures 345B are oriented differently at zone 1, zone 2, and zone 3. Notably, as illustrated in FIG. 3, zone 2 and zone 3 are located adjacent to one another, while zone 1 is located within zone 2. As illustrated, system 300 applies a voltage of 1v to active layer 340B in the area corresponding to zone 1, thereby resulting in a 90-degree phase change of the nanostructures in that area. Similarly, system 300 applies a voltage of 2v to active layer 340B in the area corresponding to zone 2, thereby resulting in a 45-degree phase change of the nanostructures in that area. Similarly, system 300 applies a voltage of 3v to active layer 340B in the area corresponding to zone 3, thereby resulting in a 22-degree phase change of the nanostructures in that area. In this way, system 300 is able to dynamically attenuate particular areas of the viewing aperture at differing amounts. Additional applications of voltages and the resulting other phase changes are discussed herein, for example, as discussed with respect to FIG. 2. Additional active layers are discussed herein, for example, active layers 140, 240.

Additionally, system 300 is able to continuously dynamically attenuate the active layer within a particular area. In such an embodiment, system 300 applies a voltage to active layer 340C, resulting in orientated nanostructures 345C. As illustrated, the voltage applied to the active layer 340C continuously varies across the zone of oriented nanostructures. In this way, system 300 dynamically attenuates the viewing aperture in a gradient pattern, for example with pixels located towards the middle of the zone having higher attenuation and those located towards the edges of the zone having lower attenuation. That is, system 300 is able to dynamically attenuate the viewing aperture at pixel level granularity.

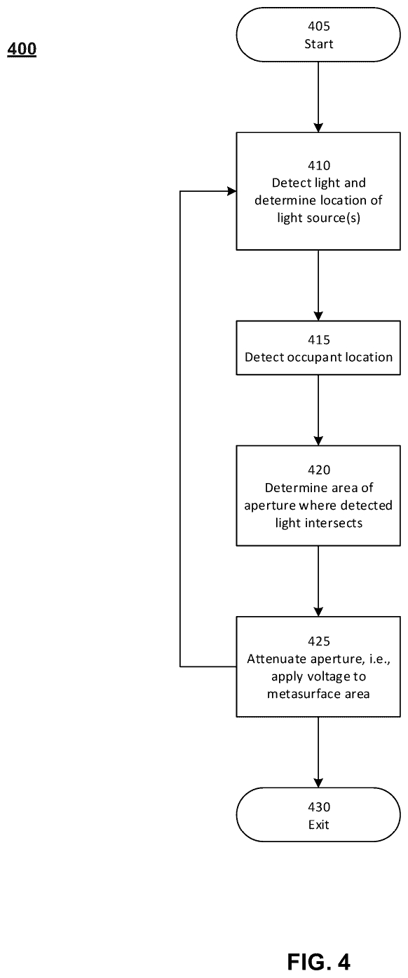

FIG. 4 depicts an illustrative flow chart of a process 400 for dynamically attenuating light transmissibility, in accordance with embodiments of the present disclosure.

At step 405, process 400 may initialize. In some embodiments, process 400 initializes when the vehicle powers on. In other embodiments, process 400 initializes in response to user input. In such an embodiment, process 400 may receive, for example, a user input selection from a user equipment device (e.g., user equipment 105, 1005, 1105, 1205, 1305, a mobile device, vehicle infotainment system), or a user input device located within the vehicle, e.g., a push button or other device located on the steering wheel of the vehicle.

At step 410, process 400 may detect light. In some embodiments, process 400 uses information received from imaging devices (e.g., imaging sensor 115, 215, 216, 915, 917) to detect light and determine the brightness of the detected light.

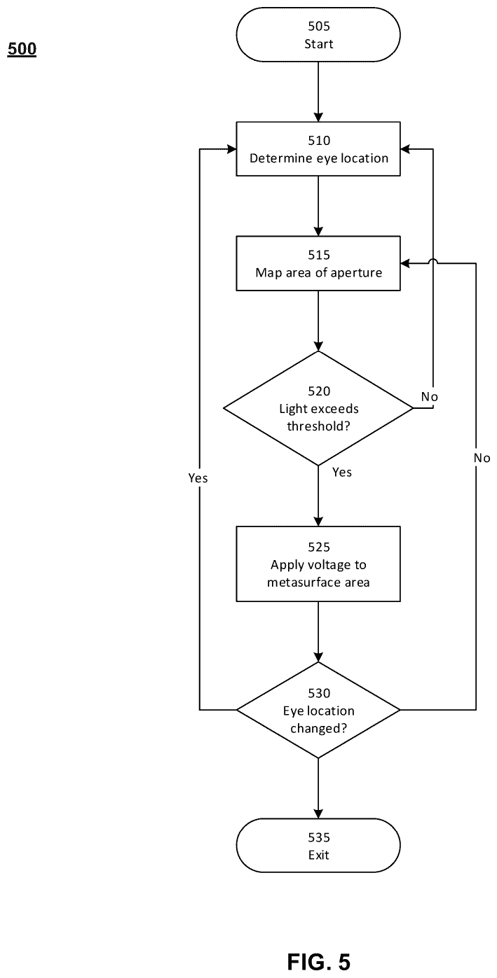

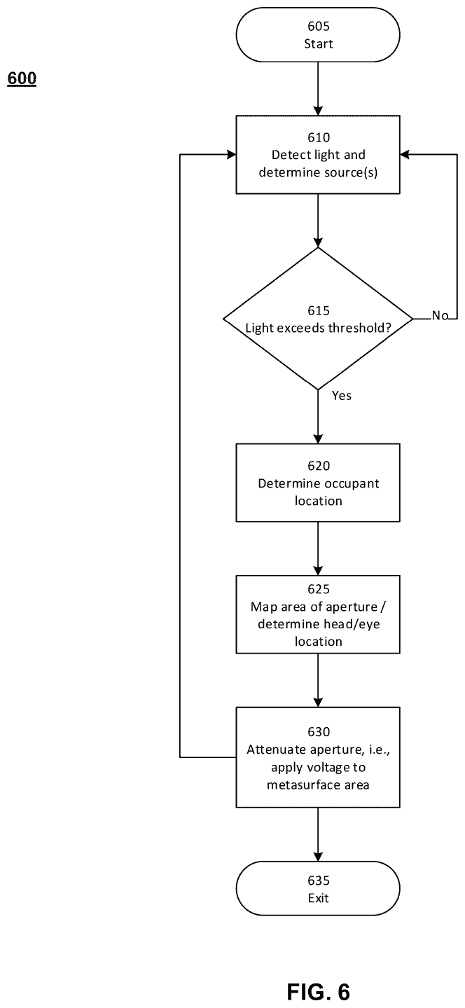

Process 400 may alternatively or additionally determine the location of the light source. In an exemplary embodiment, process 400 applies a vector processing based on a 3D co-ordinate (x,y,z) system. Such implementations include determining a vector in 3D space between a center position of a detected light source and a center position of a detected occupant's eye or head. Such a mapping or transformation process can be operated to perform processing for multiple light sources and/or multiple occupants and/or multiple eyes, and therefore identify multiple locations (or zones) of the aperture for attenuation. Such techniques can be implemented irrespective of detection technology. For example, the location of a light source is detected, for example, by camera and/or radar, LIDAR, or based on signals from known wireless systems such as 3G/4G/5G telecommunications systems, or future telecommunications systems capable of sending and receiving location data such as 6G systems, identifying the location (for example by using GPS positioning), path, and/or speed of an oncoming vehicle and thus the location of its headlights being located at the front corners of a detected oncoming vehicle. For example, the location information transmitted by an oncoming vehicle may comprise the location of a 3G/4G/5G/6G transponder unit together with a pre-configured forward offset value comprising the distance forward, parallel to the central axis of the vehicle (i.e., directly forward of the transponder unit), at which the light sources on that vehicle are located, and a lateral offset value comprising the distance perpendicular to the central axis of the vehicle that each light source is located on that vehicle. These location and offset data elements, following transmission, are sufficient to enable a vehicle receiving the signals to identify the position of each light source on that vehicle. Alternatively, the forward and lateral offset values may be applied prior to transmission, to generate two locations for transmission, each location being a location of one of the light sources on that vehicle, or may be applied, for example, at a central database. The mapping or transformation process can be repeated continuously or periodically (e.g., every second, 0.1 seconds, 0.001 seconds) to track moving light sources and occupants. In some embodiments, process 400 predicts the movement and/or locations of detected light sources over time based on predicted trajectories of the light sources relative to the occupants or vehicle, using speed, direction, path, acceleration etc. Although certain light detection and source location determinations are illustrated and described herein with respect to FIG. 4, such techniques may be applied to any of the embodiments discussed herein, without departing from the contemplated embodiments. Additional techniques for detecting light and determining the location of the light source are discussed at steps 515, 520, and 610, as discussed with respect to FIGS. 5 and 6.

At step 415, process 400 may determine the location of the head or eye position of the occupant(s). In an exemplary embodiment, process 400 uses imaging information from imaging devices (e.g., imaging sensor 216) to determine the number of occupants and their respective head or eyes. In such an example, process 400 receives information from an imaging sensor. Process 400 applies various techniques, for example, computer vision, to determine the location of one or more occupants of the vehicle. Additionally, process 400 may implement techniques to determine the eye or head position and/or orientation of one or more occupants of the vehicle using image processing. Process 400 may use the techniques disclosed in the description of system 200 for determining the head and eye positions of occupants or estimates thereof. For example, process 400 may apply a head and/or eye tracking technique that determines the location and orientation of the head and/or eyes of one or more occupants of the vehicle. In this way, process 400 determines or approximates the location and orientation of the head and/or eyes of the occupants of the vehicle to dynamically attenuate the incoming light directed at the one or more occupants.

While certain embodiments may be illustrated and discussed as using an imaging sensor to determine the location and orientation of one or more occupants of the vehicle (e.g., imaging sensor 216), process 400 need not precisely determine the location and/or orientation of the occupants in the vehicle to effectively implement the techniques and features of the present disclosure. For example, process 400 may estimate the number of occupants and their physical orientation. In such an example, process 400 may receive information relating to the presence of occupants of the vehicle. In such an example, process 400 determines the presence of occupants from, for example, seat belts or other sensors used to, e.g., implement safety features of the vehicle (e.g., airbags, restraint systems). Additionally, process 400 may receive information relating to the positioning and orientation of the seats to estimate the height of the occupants, thereby estimating the head position of vehicle occupants by, for example, receiving user input specifying the number of occupants, the height and/or head orientation/location of occupants, and the location of occupants. In such an example, a user can input such parameters in a user equipment device, e.g., user equipment 105, 1005, 1105, 1205, 1305, including a mobile device or infotainment system of the vehicle. In some embodiments, process 400 estimates the head location of one or more occupants of the vehicle. In such an example, process 400 uses a pre-programmed default height for occupants, based on an average height of an adult, wherever it is identified that a seat is occupied, and may be configured to apply voltage to larger zones of the aperture on account of the lack of precision about the location of occupants' eyes. Additional techniques for determining the location of the head or eye position of the occupant(s) are discussed herein, for example, at steps 510 and 620 as discussed with respect to FIGS. 5 and 6, and in the description of system 200.

At step 420, process 400 determines the locations of the aperture that are to be attenuated. Suitable techniques for this step were introduced in the earlier section relating to determining the location of the light source for process 400, with the description covering a range of technologies including, for example, light sensors, radar, LIDAR, and wireless signals. In an exemplary embodiment, process 400 uses imaging information from imaging devices (e.g., imaging sensor 115, 215, 216, 915, 917) to determine the area of the viewing aperture corresponding to where the detected light intersects the viewing aperture. In some embodiments, process 400 uses certain techniques, for example, a mapping or transformation, to determine a zone (or zones) of the viewing aperture corresponding to where light rays emanating from one or more detected light sources, travelling on a direct path from the identified source location (e.g., identified using the techniques disclosed herein for detecting and/or determining the position of a light source) towards the occupant's eyes or head, would intersect the aperture. Such a mapping or transformation may, for example, use identified locations of a light source and an identified position of an occupant's eye or head, to determine a location of the viewing aperture through which rays of light passing on a direct path from the light source to the occupant's eye or head intersect the aperture. In this way, system 300 determines the locations of the viewing aperture to attenuate to mitigate the intensity of incoming light. Although certain techniques for determining the location of a light source and attenuating corresponding areas of the viewing aperture may be illustrated and described with respect to a single light source and a single occupant, such techniques may be applied to any number of light sources (including zero) and any number of occupants (including zero), without departing from the contemplated embodiments.

Such mapping or transformation techniques can be implemented using vector processing based on a 3D co-ordinate (x,y,z) system, as introduced in the earlier section relating to determining the location of the light source for process 400. Such implementations include i) determining a vector in 3D space between a center position of a detected light source and a center position of a detected occupant's eye or head; ii) determining and/or storing a vector representation of the aperture surface in 3D space, by, e.g., treating the aperture as a plane or series of planes; iii) determining the point(s) in 3D space, using, e.g., vector processing, at which location(s) the vector(s) intersect the surface. Such a mapping or transformation process can be operated to perform processing for multiple light sources and/or multiple occupants and/or multiple eyes, and therefore identify multiple locations (or zones) of the aperture for attenuation. Although specific points may be identified for attenuation, any size and shape of areas (including circular areas) corresponding to such points may be attenuated, without departing from the contemplated embodiments. Such techniques can be implemented irrespective of detection technology. Such techniques can be repeated continuously or periodically (e.g., every second, 0.1 seconds, 0.001 seconds) to track and/or predict the areas of the aperture to attenuate. In some embodiments, process 400 predicts the movement and/or locations of said zones for attenuation over time based on predicted trajectories of the light sources relative to the occupants or vehicle, using speed, direction, path, acceleration etc. Although the mapping or transformation is illustrated and described herein with respect to FIG. 4, such techniques may be applied to any of the embodiments discussed herein, without departing from the contemplated embodiments. Additional techniques for determining the area of the aperture where detect light intersects are discussed herein, for example, at steps 515 and 625 as discussed with respect to FIGS. 5 and 6.

At step 425, process 400 may apply a voltage to the metasurface area. In response to determining aspects of the incoming light, dynamic polarization is applied to the identified zones of the windshield to reduce the intensity of the incoming light.

In some embodiments, process 400 applies the voltage uniformly across the entire viewing aperture. In such an embodiment, the entire viewing aperture will be attenuated evenly. In other embodiments, process 400 applies the voltage to particular areas or zones of the metasurface, resulting in corresponding zones of attenuation of the viewing aperture (for example, those illustrated and described with respect to FIG. 3).

In some embodiments, process 400 applies varying voltages to the active layer (e.g., active polarizing layer 140, 240, 340) of the metasurface at various locations, which orients nanostructures in those locations. In some embodiments, process 400 applies uniform voltages to pixels contained in a particular area, thereby creating various zones of attenuations. In such an example, process 400 applies voltages to the pixels of active layer (e.g., active layer 340A-C) corresponding to a particular area, resulting in oriented nanostructures in that area or zone (e.g., oriented nanostructures 345A-C). As a result, the viewing aperture corresponding to the area of oriented nanostructures is attenuated while the remainder of active layer remains unattenuated.

In other embodiments, process 400 applies different voltages to pixels of active layer at various zones, resulting in different levels of attenuation in those zones. As discussed herein, oriented nanostructures are oriented differently at varying locations. For example, process 400 applies a voltage of 1v to active layer in the area corresponding to a first zone, thereby resulting in a 90-degree phase change of the nanostructures in that area. Similarly, process 400 applies a voltage of 2v to active layer in the area corresponding to a second zone, thereby resulting in a 45-degree phase change of the nanostructures in that area. Similarly, process 400 applies a voltage of 3v to the active layer in the area corresponding to a third zone, thereby resulting in a 22-degree phase change of the nanostructures in that area. In this way, process 400 is able to dynamically attenuate particular areas of the viewing aperture at differing amounts.

In some embodiments, process 400 continuously dynamically attenuates the active layer within a particular area. In such an embodiment, process 400 applies a voltage to the active layer, resulting in orientated nanostructures. In such an embodiment, the voltage applied to the active layer continuously varies across the zone of oriented nanostructures, for example with pixels located towards the middle of the zone having higher attenuation and those located towards the edges of the zone having lower attenuation. In this way, process 400 dynamically attenuates the viewing aperture in a gradient pattern and, in some embodiments, process 400 dynamically attenuates the viewing aperture at pixel level granularity.

In some embodiments, process 400 may predict future locations of the light source, occupants, and/or the areas of the viewing aperture to attenuate. In such an embodiment, process 400 applies second-and/or third-order vector determination to determine the movement and/or acceleration of the light source, occupants, and/or the attenuated areas of the viewing aperture. Additional techniques for attenuating the aperture are discussed herein, for example, at steps 525 and 630 as discussed with respect to FIGS. 5 and 6.

At the conclusion of step 425, process 400 may return to step 410. In some embodiments, process 400 receives an indication to exit (e.g., discontinue attenuating). In such an embodiment, process 400 proceeds to step 430 where process 400 exits the process. It can be seen that certain elements of these operations can be combined and/or performed in a different order. For example, in an exemplary embodiment in which vector processing operations described above are performed to support the mapping/transformation operation to identify locations of the aperture to attenuate based on determined locations of light sources and occupants' eyes and/or heads, this processing can be performed at any point once the locations of the light sources and occupants' head and/or eye positions have been determined by any means (such that the vector representing the direct path(s) between the respective location pairs can be determined). It can be seen, for example, that determining the locations of occupant's eyes and/or head could be determined before or after determining the location of light sources, or these could be performed simultaneously. It can also be seen that steps 405 and 430 may be omitted (for example in a system where the process remains active without initialization or exit), the detecting of light in step 410 may be omitted (for example, in embodiments which do not rely on the detection of light or a separate step thereof), and the vector processing operations illustrated and described with respect to step 420 (for example in a system where the whole aperture is attenuated, rather than individual zones, upon the detection of an oncoming light source).

FIG. 5 depicts an illustrative flow chart of a process 500 for dynamically attenuating light transmissibility, in accordance with embodiments of the present disclosure.

At step 505, process 500 may initialize. In some embodiments, process 500 initializes when the vehicle powers on. In other embodiments, process 500 initializes in response to user input. In such an embodiment, process 500 may receive, for example, a user input selection from a user equipment device (e.g., user equipment 105, 1005, 1105, 1205, 1305, a mobile device, vehicle infotainment system), or a user input device located within the vehicle, e.g., a push button or other device located on the steering wheel of the vehicle.

At step 510, process 500 may determine the eye or head location of one or more occupants of a vehicle. In some embodiments, process 500 determines the head and/or eye position of one or more occupants of the vehicle (e.g., vehicle 110, 210, 810, 910, 1310). For example, process 500 receives information from an imaging sensor (e.g., imaging sensor 115, 215, 216, 915, 917) to determine the head and/or eye location of one or more occupants of the vehicle. Process 500 applies various techniques, for example, computer vision, to determine the location of one or more occupants of the vehicle using image processing. Process 500 may use the techniques disclosed in the description of system 200 for determining the head and eye positions of occupants or estimates thereof, and step 415.

Additionally, process 500 may implement techniques to determine the eye position and/or orientation of one or more occupants of the vehicle. For example, process 500 applies an eye and/or head tracking technique that determines the location and orientation of the eyes and/or heads of one or more occupants of the vehicle.

While certain embodiments may be illustrated and discussed as using an imaging sensor to determine the location and orientation of one or more occupants of the vehicle, process 500 determines the location and/or orientation of the occupants of the vehicle using differing and/or a combination of techniques. In such an exemplary embodiment, process 500 estimates the number of occupants and their orientation within the vehicle. In such an example, process 500 may receive information relating to the presence of occupants of the vehicle. For example, process 500 determines the presence of occupants from, for example, seat belts or other sensors used to, e.g., implement safety features of the vehicle (e.g., airbags). Additionally, process 500 may receive information relating to the positioning and orientation of the seats to estimate the height of the occupants, thereby estimating the head position of vehicle occupants. For example, process 500 receives user input (e.g., from user equipment 105, 1005, 1105, 1205, 1305) specifying the number of occupants, the height and/or head orientation/location of occupants, and the location of occupants. In such an example, a user can input such parameters in a user equipment device, e.g., a mobile device or infotainment system of the vehicle. In other examples, process 500 estimates the location and orientation of occupants' eyes by receiving seat positioning information from, e.g., electronic onboard seat position systems. Additional techniques for determining eye location are discussed herein, for example, at steps 415 and 620 as discussed with respect to FIGS. 4 and 6 and in system 200.

At step 515, process 500 may map the area of the aperture. In an exemplary embodiment, process 500 uses imaging information from imaging devices (e.g., imaging sensor 115, 215, 216, 915, 917) to determine the area of the viewing aperture to attenuate. In some embodiments, process 500 uses certain techniques, for example, a mapping or transformation, to determine a zone (or zones) of the viewing aperture corresponding to where light rays emanating from one or more detected incoming light sources, travelling on a direct path from the identified source location (e.g., identified using the techniques disclosed herein for detecting and/or determining the position of a light source) towards an occupant's eyes or head would intersect the aperture. Such a mapping or transformation may, for example, use an identified location of a light source and an identified position of an occupant's eye or head, to determine a location of the viewing aperture through which rays of light passing on a direct path from the light source to the occupant's eye or head intersect. In this way, process 500 determines the locations of the viewing aperture to attenuate to mitigate the intensity of incoming light. Although certain techniques for determining the location of a light source and attenuating corresponding areas of the viewing aperture may be illustrated and described with respect to a single light source and a single occupant's eye or head, such techniques may be applied to any number of light sources (including zero) and any number of occupants' eyes or heads (including zero), without departing from the contemplated embodiments.

Such mapping or transformation techniques can be implemented using simple vector processing based on a 3D co-ordinate (x,y,z) system. Such implementations include i) determining a vector in 3D space between a center position of a detected light source and a center position of a detected occupant's eye or head; ii) determining and/or storing a vector representation of the aperture surface in 3D space, by, e.g., treating the aperture as a plane or series of planes; iii) determining the point(s) in 3D space, using, e.g., vector processing, at which location(s) the vector(s) intersect the surface. Such a mapping or transformation process can be operated to perform processing for multiple light sources and/or multiple occupants and/or multiple eyes, and therefore identify multiple locations (or zones) of the aperture for attenuation. Although specific points may be identified for attenuation, any size and shape of areas (including circular areas) corresponding to such points may be attenuated, without departing from the contemplated embodiments. Such techniques can be implemented irrespective of detection technology. For example, the location of a light source is detected, for example, by camera and/or radar, LIDAR, or inferred, for example, based on 3G/4G/5G/6G signals identifying the location, path, and/or speed of an oncoming vehicle and thus, by inference, the location of its headlights being located at the front corners of a detected oncoming vehicle. In the case of 3G/4G/5G/6G signals, for example, the location information transmitted may comprise the location of a 3G/4G/5G/6G transponder unit together with a pre-configured forward offset value comprising the distance forward, parallel to the central axis of the vehicle (i.e., directly forward of the transponder unit), at which the light sources on that vehicle are located, and a lateral offset value comprising the distance perpendicular to the central axis of the vehicle that each light source is located on that vehicle. These location and offset data elements, following transmission, are sufficient to enable a vehicle receiving the signals to identify the position of each light source on that vehicle. Alternatively, the forward and lateral offset values may be applied prior to transmission, to generate two locations for transmission, each location being a location of one of the light sources on that vehicle, or may be applied, for example, at a central database. The mapping or transformation techniques can be repeated continuously or periodically (e.g., every second, 0.1 seconds, 0.001 seconds) to track moving light sources and occupants. In some embodiments, process 500 predicts the movement and/or locations of said zones for attenuation over time based on predicted trajectories of the light sources relative to the occupants or vehicle, using speed, direction, path, acceleration etc. Although the mapping or transformation is illustrated and described herein with respect to FIG. 5, such techniques may be applied to any of the embodiments discussed herein, without departing from the contemplated embodiments. Additional techniques for mapping the area of the aperture are discussed herein, for example, at steps 420 and 625 as discussed with respect to FIGS. 4 and 6.

At step 520, process 500 may determine whether the light exceeds a threshold. In some embodiments, process 500 uses information received from imaging devices (e.g., imaging sensor 115, 215, 216, 915, 917) to determine the brightness and compares it against a threshold.

The threshold is set by, for example, process 500, and is expressed in any manner suitable for measuring brightness (luminosity), e.g., lumens (i.e., measure of the total quantity of visible light emitted by a light source per unit of time) or candela (i.e., luminous power per unit solid angle emitted by a light source in a particular direction), or any other suitable technique for measuring. In other embodiments, a threshold may be set by a user (i.e., an occupant of the vehicle), using, for example, a user equipment device having user selectable inputs. In such an embodiment, the user may specify a threshold or certain parameters pertaining to the threshold. For example, the user may specify a maximum difference between the darkest portion of the viewing aperture and the brightest portion of the viewing aperture that is acceptable. Conversely, the user may specify that the difference between the darkest portion and brightest portion shall be restricted to a threshold. In some embodiments, the threshold may be associated with a user profile. In some embodiments, the user profile may also be associated with a user equipment device. Additional implementations of configuring process 500 using a user input device are discussed herein, for example, as illustrated and described with respect to FIGS. 10-12.

In some embodiments, the threshold is static, i.e., does not change. In other embodiments, the threshold is dynamic, i.e., varies over time and, in some embodiments, varies with respect to environmental factors. In some embodiments, the threshold is absolute. In such an embodiment, process 500 compares the detected light value to the absolute threshold value to determine whether detected light exceeds the threshold. In other embodiments, the threshold is relative. In such an exemplary embodiment, process 500 determines the darkest portion of the viewing aperture and the brightest portion to determine the difference in the brightest vs. darkest areas. In such an embodiment, the threshold value is a maximum allowable difference between the brightest portion of the aperture and the darkest.

In some embodiments, the threshold value depends on the time of day. In such an embodiment, process 500 applies different thresholds depending on whether the aperture is exposed to daylight vs. artificial lights (e.g., streetlights). In such an embodiment, process 500 may apply a lower threshold for nighttime driving and a higher threshold for daytime driving. Although certain types of thresholds are illustrated and described, any type of threshold, including combinations of the various types of thresholds discussed herein, may be implemented, without departing from the contemplated embodiments.

In the event that process 500 determines that the light does not exceed a threshold, process 500 returns to step 510. In the event that process 500 determines that the light exceeds a threshold, process 500 proceeds to step 525.

At step 525, process 500 may apply a voltage to the metasurface area. In response to determining aspects of the incoming light, dynamic polarization is applied to the identified zones of the windshield to reduce the intensity of the incoming light.

In some embodiments, process 500 applies the voltage uniformly across the entire viewing aperture. In such an embodiment, the entire viewing aperture will be attenuated evenly. In other embodiments, process 500 applies the voltage to particular areas or zones of the metasurface, resulting in corresponding zones of attenuation of the viewing aperture.

In some embodiments, process 500 applies varying voltages to the active layer (e.g., active polarizing layer 140, 240, 340) of the metasurface at various locations, which orients nanostructures in those locations. In some embodiments, process 500 applies uniform voltages to pixels contained in a particular area, thereby creating various zones of attenuations. In such an example, process 500 applies voltages to the pixels of active layer (e.g., active layer 340A-C) corresponding to a particular area, resulting in oriented nanostructures in that area or zone (e.g., oriented nanostructures 345A-C). As a result, the viewing aperture corresponding to the area of oriented nanostructures is attenuated while the remainder of active layer remains unattenuated.

In other embodiments, process 500 applies different voltages to pixels of active layer at various zones, resulting in different levels of attenuation in those zones. As discussed herein, oriented nanostructures are oriented differently at varying locations. For example, process 500 applies a voltage of 1v to active layer in the area corresponding to a first zone, thereby resulting in a 90-degree phase change of the nanostructures in that area. Similarly, process 500 applies a voltage of 2v to active layer in the area corresponding to a second zone, thereby resulting in a 45-degree phase change of the nanostructures in that area. Similarly, process 500 applies a voltage of 3v to the active layer in the area corresponding to a third zone, thereby resulting in a 22-degree phase change of the nanostructures in that area. In this way, process 500 is able to dynamically attenuate particular areas of the viewing aperture at differing amounts.

In some embodiments, process 500 continuously dynamically attenuates the active layer within a particular area. In such an embodiment, process 500 applies a voltage to the active layer, resulting in orientated nanostructures. In such an embodiment, the voltage applied to the active layer continuously varies across the zone of oriented nanostructures. In this way, process 500 dynamically attenuates the viewing aperture in a gradient pattern and, in some embodiments, process 500 dynamically attenuates the viewing aperture at pixel level granularity, for example, with pixels located towards the middle of the zone having higher attenuation and those located towards the edges of the zone having lower attenuation. Additional techniques for applying voltage to the metasurface area are discussed herein, for example, at steps 420 and 625 as discussed with respect to FIGS. 4 and 6.

At step 530, process 500 may determine whether the eye location has changed. In an embodiment, process 500 receives information related to the location and/or orientation of one or more occupants of the vehicle. Various techniques are discussed herein for determining such information, for example, those discussed with respect to step 510. Process 500 compares that information to previously determined locations/orientations to determine whether the locations of one or more of the occupants have changed. For example, process 500 receives information from an imaging sensor (e.g., imaging sensor 115, 215, 216, 915, 917) to determine the head and/or eye location of one or more occupants of the vehicle. Process 500 applies various techniques, for example, computer vision, to determine the location of one or more occupants of the vehicle.

Additionally, process 500 may implement techniques to determine the eye position and/or orientation of one or more occupants of the vehicle. For example, process 500 applies an eye tracking technique that determines the location and orientation of the eyes and/or head of one or more occupants of the vehicle. Additional techniques for determining eye and/or head location are discussed herein, for example, at steps 415 and 620 as discussed with respect to FIGS. 4 and 6, and in the description of system 200.

In the event that process 500 determines that the eye location has changed, process 500 returns to step 510. In the event that process 500 determines that the eye location has not changed, process 500 returns to step 515. In the event that process 500 receives an indication to discontinue mapping and attenuating (e.g., the vehicle is powered off or a user disengages the system), process 500 proceeds to step 535, at which process 500 may exit operation.

In some embodiments, process 500 may predict future locations of the light source, occupants, and/or the areas of the viewing aperture to attenuate. In such an embodiment, process 500 applies second-and/or third-order vector determination to determine the movement and/or acceleration of the light source, occupants, and/or the attenuated areas of the viewing aperture. It can be seen that certain elements of these operations can be combined and/or performed in a different order. For example, in an exemplary embodiment in which vector processing operations described above are performed to support the mapping/transformation operation to identify locations of the aperture to attenuate based on determined locations of light sources and occupants' eyes and/or heads, this processing can be performed at any point once the locations of the light sources and occupants' heads and/or eyes have been determined by any means (such that the vector representing the direct path(s) between the respective location pairs can be determined). It can be seen, for example, that determining the locations of occupant's eyes and/or head in step 510 could be determined before or after determining the location of light sources in step 515, or these could be performed simultaneously. Furthermore, it can be seen that steps 505 and 535 can be optionally omitted (for example in a system where the process remains active without initialization or exit), checking whether the light exceeds a threshold (at step 520) can be optionally omitted (where a threshold-free implementation is adopted), and checking whether eye location changed (at step 530) could also be optionally omitted (for example in a system where the loop is performed continuously, with an arrow from step 525 feeding back directly to step 510).

FIG. 6 depicts an illustrative flow chart of a process 600 for dynamically attenuating light transmissibility, in accordance with embodiments of the present disclosure.

At step 605, process 600 may initialize. In some embodiments, process 600 initializes when the vehicle (e.g., vehicle 110, 210, 810, 910, 1310) powers on. In other embodiments, process 600 initializes in response to user input. In such an embodiment, process 600 may receive, for example, a user input selection from a user equipment device (e.g., user equipment 105, 1005, 1105, 1205, 1305 including a mobile device, or a vehicle infotainment system), or a user input device located within the vehicle, e.g., a push button or other device located on the steering wheel of the vehicle. In some embodiments, process 600 initializes in response to an event occurring. For example, process 600 may be configured to initialize when the vehicle's headlights are turned on. In another example, process 600 initializes when a certain amount of light is detected. In another example, process 600 initializes at a certain time of day, e.g., at night or certain times of the day (e.g., at sunrise or sunset). In such an example, process 600 may receive location information (e.g., GPS location from a third-party service or as determined by the vehicle's onboard systems) to determine whether the vehicle is at a location and time where it is sunrise or dusk.

At step 610, process 600 may detect light. In some embodiments, process 600 uses information received from imaging devices to detect light and determine the brightness of the detected light. Additional techniques for detecting light and determining its source are discussed herein, for example, at steps 410, 515, and 520 as discussed with respect to FIGS. 4 and 5.

At step 615, process 600 may determine whether the detected light (e.g., the light detected at step 610) exceeds a threshold. In some embodiments, the threshold is set by, for example, process 600. In other embodiments, the threshold may be set by a user (i.e., an occupant of the vehicle), using, for example, a user equipment device having user selectable inputs. In such an embodiment, the user may specify the threshold or certain parameters pertaining to the threshold. For example, the user may specify that a large difference in the darkest portion of the viewing aperture and the brightest portion of the viewing aperture is acceptable. Conversely, the user may specify that the difference of brightness be restricted. In some embodiments, the threshold may be associated with a user profile. In some embodiments, the user profile may also be associated with a user equipment device.

In some embodiments, the threshold is static, i.e., does not change. In other embodiments, the threshold is dynamic, i.e., varies over time and, in some embodiments, varies with respect to environmental factors.

In some embodiments, the threshold is absolute. In such an embodiment, process 600 compares the detected light value to the absolute threshold value to determine whether detected light exceeds the threshold. In other embodiments, the threshold is relative. In such an exemplary embodiment, process 600 determines the darkest portion of the viewing aperture and the brightest portion to determine the difference in the brightest versus the darkest areas. In such an embodiment, the threshold value may be expressed as a maximum allowable difference between the brightest portion of the aperture and the darkest.

In some embodiments, the threshold value depends on the time of day. In such an embodiment, process 600 applies different thresholds depending on whether the aperture is exposed to daylight or artificial lights (e.g., streetlights). In such an embodiment, process 500 may apply a lower threshold for nighttime driving and a higher threshold for daytime driving.

Although certain types of thresholds are illustrated and described, any type of threshold, including combinations of the various types of thresholds discussed herein, may be implemented, without departing from the contemplated embodiments. Additional techniques for determining whether light exceeds a threshold are discussed herein, for example, at steps 410, 515, and 520 as discussed with respect to FIGS. 4 and 5. In the event that process 600 determines that the light does not exceed a threshold, process 600 returns to step 610. In the event that process 600 determines that the light exceeds a threshold, process 600 proceeds to step 620.

At step 620, process 600 may determine the respective locations of occupants within the vehicle. In an exemplary embodiment, process 600 uses imaging information from imaging devices (e.g., imaging sensor 216) to determine their respective head(s) or eyes using image processing. Process 600 may use the techniques disclosed in the description of system 200 for determining the head and/or eye positions of occupants or estimates thereof. In such an example, process 600 receives information from an imaging sensor. Process 600 applies various techniques, for example, computer vision, to determine the location of one or more occupants of the vehicle. Additionally, process 600 may implement techniques to determine the eye or head position and/or orientation of one or more occupants of the vehicle. For example, process 600 may apply an eye and/or head tracking technique that determines the location and orientation of the eyes and/or heads of one or more occupants of the vehicle. In this way, process 600 determines or approximates the location and orientation of the eyes of the occupants of the vehicle to dynamically attenuate the incoming light directed at the one or more occupants.

While certain embodiments may be illustrated and discussed as using an imaging sensor to determine the location and orientation of one or more occupants of the vehicle (e.g., imaging sensor 216), process 600 need not precisely determine the location and/or orientation of the occupants in the vehicle to effectively implement the techniques and features of the present disclosure. For example, process 600 may estimate the locations of occupants and their physical orientation. In such an example, process 600 may receive information relating to the presence of occupants of the vehicle. In such an example, process 600 determines the presence of occupants from, for example, seat belts or other sensors used to, e.g., implement safety features of the vehicle (e.g., airbags, restraint systems). Additionally, process 600 may receive information relating to the positioning and orientation of the seats to estimate the height of the occupants, thereby estimating the head position of vehicle occupants by, for example, receiving user input specifying the number of occupants, the height and/or head orientation/location of occupants, and the location of occupants. In such an example, a user can input such parameters in a user equipment device, e.g., user equipment 105, 1005, 1105, 1205, 1305, including a mobile device or infotainment system of the vehicle. In some embodiments, process 600 estimates the head location of one or more occupants of the vehicle. In such an example, process 600 uses a pre-programmed default height for occupants, based on an average height of an adult, wherever it is identified that a seat is occupied, and may be configured to apply voltage to larger zones of the aperture on account of the lack of precision about the location of occupants' eyes. Additional techniques for determining the location of occupants are discussed herein, for example, at steps 415 and 510 as discussed with respect to FIGS. 4 and 5 and in system 200.

At step 625, process 600 may map the area of the aperture to be dynamically attenuated. The disclosure provided for step 515 is equally applicable here. In an exemplary embodiment, process 600 uses imaging information from imaging devices to determine the area of the viewing aperture to attenuate. In some embodiments, process 600 uses certain techniques, for example, a mapping or transformation, to determine a zone on the viewing aperture that a light ray from a detected incoming light source travelling along an occupant's line of sight will intersect the aperture. Additional techniques for mapping the area of the aperture and determining head/eye location are discussed herein, for example, at steps 415, 420, 510 and 515 as discussed with respect to FIGS. 4 and 5 and system 200.

At step 630, process 600 may apply a voltage to the metasurface in the areas where the identified light rays would intersect the viewing aperture. In response to determining aspects (e.g., location, orientation, and/or intensity) of the incoming light rays, dynamic polarization is applied to the identified zones of the windshield to reduce the intensity of the incoming light rays.

In some embodiments, process 600 applies the voltage uniformly across the entire viewing aperture. In such an embodiment, the entire viewing aperture will be attenuated evenly. In other embodiments, process 600 applies the voltage to particular areas or zones of the metasurface, resulting in corresponding zones of attenuation of the viewing aperture.

In some embodiments, process 600 applies varying voltages to the active layer of the metasurface at various locations, which orients nanostructures in those locations. In such an embodiment, process 600 applies uniform voltages to pixels contained in a particular area, thereby creating various zones of attenuations. In such an example, process 600 applies voltages to the pixels of active layer (e.g., active polarizing layer 140, 240, 340) corresponding to a particular area, resulting in oriented nanostructures in that area or zone (e.g., oriented nanostructures 145, 345A-C). As a result, the viewing aperture corresponding to the area of oriented nanostructures is attenuated while the remainder of active layer remains unattenuated.

In other embodiments, process 600 applies different voltages to pixels of active layer at various locations within certain zones, resulting in different levels of attenuation in those zones. As discussed herein, nanostructures may be oriented differently at varying locations. For example, process 600 applies a voltage of 1v to active layer in the area corresponding to a first zone, thereby resulting in a 90-degree phase change of the nanostructures in that area. Similarly, process 600 applies a voltage of 2v to active layer in the area corresponding to a second zone, thereby resulting in a 45-degree phase change of the nanostructures in that area. Similarly, process 600 applies a voltage of 3v to the active layer in the area corresponding to a third zone, thereby resulting in a 22-degree phase change of the nanostructures in that area. In this way, process 600 is able to dynamically attenuate particular areas of the viewing aperture at differing amounts.

In some embodiments, process 600 continuously dynamically attenuates the active layer within a particular area. In such an embodiment, process 600 applies a voltage to the active layer, resulting in orientated nanostructures. In such an embodiment, the voltage applied to the active layer continuously varies across the zone of oriented nanostructures. In this way, process 600 dynamically attenuates the viewing aperture in a gradient pattern and is able to dynamically attenuate the viewing aperture at pixel level granularity, for example with pixels located towards the middle of the zone having higher attenuation and those located towards the edges of the zone having lower attenuation. After step 630, process 600 returns to step 610. If process 600 receives an indication of terminating the process (e.g., that the vehicle is powering down), process 600 proceeds to step 635 at the conclusion of step 630. At step 635, process 600 exits operation. Additional techniques for attenuating the aperture are discussed herein, for example, at steps 425 and 525 as discussed with respect to FIGS. 4 and 5. It can be seen that certain elements of these operations can be combined and/or performed in a different order. For example, in an exemplary embodiment in which vector processing operations described above are performed to support the mapping/transformation operation to identify locations of the aperture to attenuate based on determined locations of light sources and occupants' eyes and/or heads, this processing can be performed at any point once the locations of the light sources and occupants' heads and/or eyes have been determined by any means (such that the vector representing the direct path(s) between the respective location pairs can be determined). It can be seen, for example, that determining the locations of occupant's eyes and/or head in step 620 could be determined before or after determining the location of light sources in step 625, or these could be performed simultaneously. Furthermore, it can be seen that steps 605 and 635 can be optionally omitted (for example in a system where the process remains active without initialization or exit), and detecting light at step 610 and checking a threshold at step 615 could also be optionally omitted.

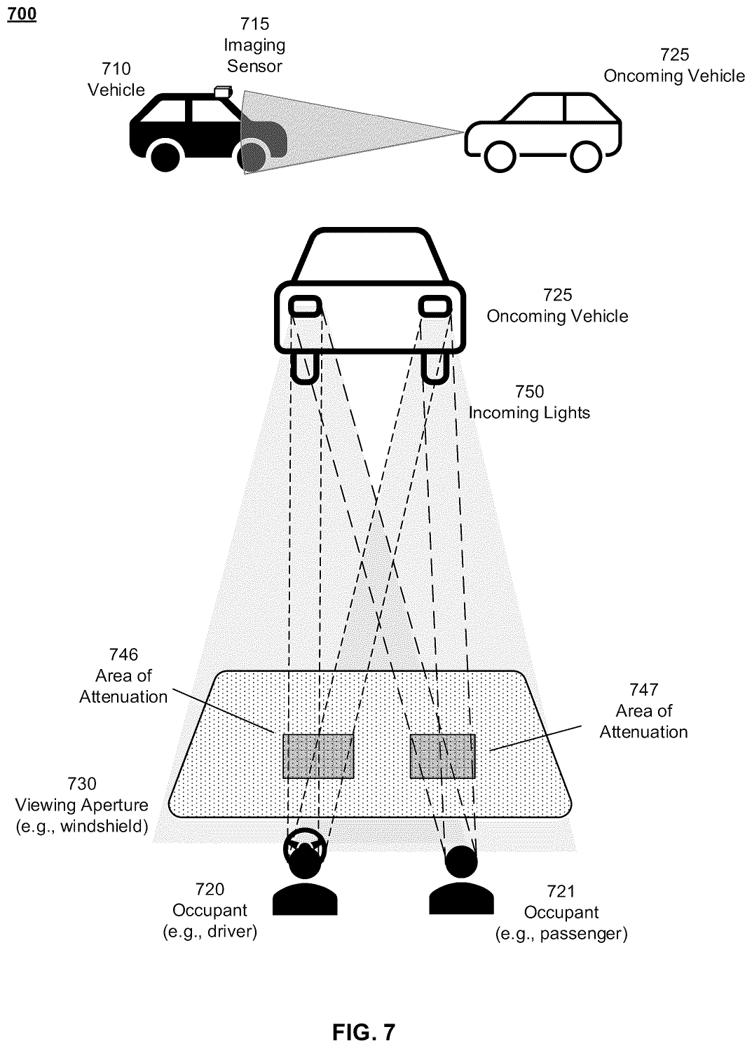

FIG. 7 illustrates an exemplary embodiment of the present disclosure where vehicle 710 includes multiple occupants. As illustrated, system 700 includes vehicle 710 containing occupant 720 (e.g., driver) and occupant 721 (e.g., passenger). Vehicle 710 may optionally include imaging sensor 715 that detects incoming lights 750. Oncoming vehicle 725 emits incoming lights 750 from, e.g., its headlights.

In an exemplary embodiment, system 700 determines the location of oncoming vehicle, using various techniques discussed herein (e.g., at step 410 discussed with respect to FIG. 4, step 515 discussed with respect to FIG. 5, step 610 discussed with respect to FIG. 6). System 700 may additionally determine the locations of viewing aperture 730 that are to be attenuated based on the intensity and location of the source of incoming lights 750 (i.e., the headlights of oncoming vehicle 715) using, for example, various techniques discussed herein (e.g., at step 420 discussed with respect to FIG. 4, step 515 discussed with respect to FIG. 5, step 625 discussed with respect to FIG. 6).

As illustrated, system 700 determines area of attenuation 746, 747 based on the location of the light sources of incoming lights 750 (i.e., the left and right headlight of oncoming vehicle 725). The size and location of area of attenuation 746 corresponds to the areas of viewing aperture 730 that correspond to where incoming lights 750 intersect viewing aperture 730 on a direct path from the left and right headlights of oncoming vehicle 725 to occupant 720. Similarly, the size and location of area of attenuation 747 corresponds to the areas of viewing aperture 730 that correspond to where incoming lights 750 intersect viewing aperture 730 on a direct path from the left and right headlights of oncoming vehicle 725 to occupant 721. Although area of attenuation 746, 747 are illustrated as generally rectangular, any size and shape of area of attenuation 746, 747 may be applied without departing from the contemplated embodiments. Additionally, the size, shape, and amount of attenuation applied to area of attenuation 746, 747 need not be uniform or the same. For example, area of attenuation 746 may be of a different size, shape, and level of attenuation than area of attenuation 747. Moreover, although two areas of attenuation 746, 747 are illustrated and described, any number, size, shape, and level of attenuation may be applied without departing from the contemplated embodiments.

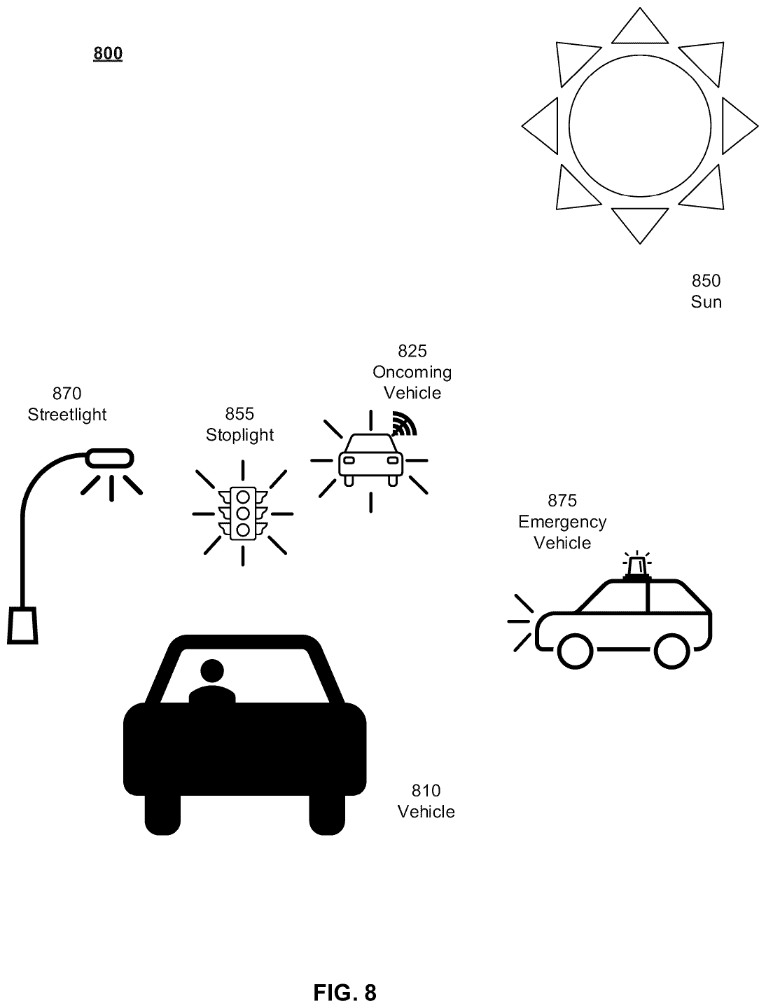

FIG. 8 illustrates various exemplary light sources that are detected and attenuated, according to various embodiments of the present disclosure. As illustrated, vehicle 810 is equipped with a dynamic light attenuation system, as discussed herein. Light emanating from various sources, for example, oncoming vehicle 825, is detected and attenuated. As illustrated, oncoming vehicle 825 emits light from, for example, its headlights, which is detected and attenuated by attenuation system 800 implemented at vehicle 810.

The light attenuation system implemented at vehicle 810 is additionally capable of detecting and attenuating light from other sources. For example, stop light 855 and streetlight 870 emit light. In the event that the light intensity from such light sources is determined to be above a threshold, light attenuation system 800 of vehicle 810 attenuates the light that passes through the viewing aperture of vehicle 810 (e.g., vehicle's 810 windshield). Various techniques for determining and applying intensity thresholds are discussed herein, for example, as illustrated and described with respect to FIGS. 5 and 6.

Emergency vehicles typically emit bright lights, and such light is especially conspicuous at night. For example, emergency vehicle 875 emits light from its headlights and also from its emergency lights. In such an embodiment, light attenuation system 800 detects incoming light from emergency vehicle 875 and attenuates it. In some embodiments, the light attenuation system of vehicle 810 may be configured to detect light emitting from an emergency vehicle and not attenuate that light significantly (or at all) so as to ensure the awareness of the driver of vehicle 810 of the presence of emergency vehicle 875 is not impacted. In such an embodiment, light attenuation system 800 determines that the incoming light emanates from an emergency vehicle (e.g., emergency vehicle 875). Various techniques may be applied in determining that the detected light emanates from an emergency vehicle. For example, system 800 may be configured so that certain wavelengths and/or intensities of light (e.g., those that are typically emitted from emergency vehicles) are detected and not attenuated. In another example, system 800 is alerted to the presence of an emergency vehicle. For example, the location of emergency vehicle 875 is relayed to nearby vehicles by, for example, emergency vehicle broadcasting a signal that is detectable by nearby vehicles. That location information is received by system 800 and is used to determine the presence of emergency vehicle 875. In such an embodiment, system 800 suspends or pauses or restricts the extent of operation of the light attenuation system 800 of vehicle 810 to ensure that the driver of vehicle 810 is properly alerted to the presence of emergency vehicle 875.

In another embodiment, system 800 detects the light emitting from sun 850. In such an embodiment, light attenuation system 800 of vehicle 810 detects the intensity and location of the source of light rays emitting from sun 875 and, optionally, the zones of the aperture that require attenuation to lower the intensity of the light rays entering the driver's eyes. Techniques disclosed herein may be applied, for example, those discussed with respect to step 515 of FIG. 5. As illustrated, based on a high light intensity of the sun 850, system 800 may be implemented to apply larger attenuation areas, up to an including the entire viewing aperture. Additionally, system 800 may use other techniques to supplement such information. For example, system 800 determines location of vehicle 810 (by, e.g., GPS or other locating techniques) and uses that information along with the vehicle's 810 orientation to determine the location of sun 850 relative to vehicle 810. Although various light sources are illustrated and described, any light emitting from any light source may be detected and attenuated according to the techniques described herein, without departing from the contemplated embodiments. Attenuation can then be performed as previously described either across the entire viewing aperture or in the determined areas of the aperture to attenuate the rays entering the driver's and/or occupants' eyes.

In another exemplary embodiment of the present disclosure and with reference to FIG. 9, dynamic light attenuation system 900 determines the presence and location of other vehicles on a roadway. As illustrated, vehicle 910 detects the presence of oncoming vehicle 925. As discussed herein, vehicle 910 determines the presence of oncoming vehicle 925 using imaging sensor 915. Imaging sensor 915 may be embodied by any sensor or photodetector capable of detecting light of any wavelength, either within or outside of the visible spectrum. In some embodiments, system 900 implements other techniques to determine the presence and/or orientation of oncoming vehicle 925.

In some embodiments, system 900 uses a LIDAR system implemented at vehicle 910. In such an embodiment, imaging sensor 915 is embodied by a light sensor. Alternatively or in addition, vehicle 910 may have multiple imaging sensors implemented thereon. For example, vehicle 910 may include imaging sensors 915, 917 located at the corners of vehicle 910. Although four imaging sensors 917 may be illustrated and described with respect to FIG. 9, any number of imaging sensors 917 may be implemented, without departing from the contemplated embodiments.

In an exemplary embodiment, LIDAR sensor 915 detects the presence of oncoming vehicle 925. Additionally, system 900 determines the orientation of oncoming vehicle 910 using the LIDAR information from LIDAR sensor 915 to determine the location and orientation of the exterior surfaces of oncoming vehicle 925, and to identify one or more locations of the aperture to attenuate, for example, using the techniques illustrated and described with respect to FIGS. 4 and 5. In some embodiments, system 900 also uses information from a front facing video camera implemented at vehicle 910 to determine the presence and orientation of oncoming vehicle 925 and the light emitted from oncoming vehicle 925. Additionally, system 900 may use information from a rear facing camera (e.g., imaging sensor 216 as discussed with respect to FIG. 2) to further determine the presence and orientation of oncoming vehicle 925. In this way, system 900 increases the accuracy and robustness of its light detection.

In another exemplary embodiment, system 900 uses telecommunication networks to determine the presence and/or orientation of vehicles. In such an exemplary embodiment, system 900 includes cellular network sensors that detect the presence and/or orientation of devices emitting cellular signals. For example, IoT sensors based on known 3G/4G/5G telecommunications systems, or any future telecommunications systems capable of sending and receiving location data, such as 6G systems, may be implemented at vehicle 910, oncoming vehicle 925, and/or oncoming vehicle 930.

The information collected with such IOT sensors enables system 900 to determine the position and/or the speed of oncoming vehicles 925, 930 either relative to vehicle 910 or in absolute terms. System 900 uses such information to determine (in some embodiments, by inference) the position of light sources at the front corner positions of oncoming vehicles 925, 930. The techniques illustrated and described with respect to step 515 of FIG. 5 may be applied for processing based, for example, on the inferred positions of headlamps at the front corners of the detected vehicle. In the case of 3G/4G/5G/6G signals, for example, the location information transmitted may comprise the location (for example a GPS location) of a 3G/4G/5G/6G transponder unit together with a pre-configured forward offset value comprising the distance forward, parallel to the central axis of the vehicle (i.e., directly forward of the transponder unit), at which the light sources on that vehicle are located, and a lateral offset value comprising the distance perpendicular to the central axis of the vehicle that each light source is located on that vehicle. These location and offset data elements, following transmission, are sufficient to enable a vehicle receiving the signals to identify the position of each light source on that vehicle, without the need to detect light emanating from the vehicle. Alternatively, the forward and lateral offset values may be applied prior to transmission, to generate two locations for transmission, each location being a location of one of the light sources on that vehicle, or may be applied, for example, at a central database.

In addition to 3G/4G/5G/6G network sensors, system 900 may leverage other types of wireless communication networks to determine the presence and orientation of oncoming vehicles 925, 930. In an exemplary embodiment, system 900 uses LTE Direct D2D (device-to-device) emitting from oncoming vehicles 925, 930 (or occupants of oncoming vehicles 923, 930) to determine their presence and/or location. In such an embodiment, LTE Direct D2D signals can be detected/received over distances exceeding one kilometer. The techniques illustrated and described above with respect to 3G/4G/5G/6G and step 515 of FIG. 5 may be applied for processing based, for example, on the inferred positions of headlamps at the front corners of the detected vehicle.

In some embodiments, system 900 determines the presence and distance of oncoming vehicles 925, 930 based on the characteristics of signals emitted from the oncoming vehicles. For example, V2V technology using 5.9 GHz spectrum may be used to transmit information among vehicles that are sufficiently close to one another. In such an example, oncoming vehicles 925, 930 broadcast vehicle identity information. From that information, system 900 determines the type of vehicle including its lighting capabilities. The intensity of such a signal can also be used to determine the distance of the source (i.e., oncoming vehicles 925, 930) to vehicle 910. In other embodiments, system 900 uses a signal in compliance with SAE J2735-defined Basic Safety Message (BSM) message. In this way, vehicle 910 obtains information from the broadcasted message before the occupants of vehicle 910 area able to see the oncoming vehicles or their headlights. An advantage of using such broadcasted signals (or other wireless networks) is that oncoming vehicles 925, 930 need not be visible to the occupants or imaging sensors of vehicle 910. Such an implementation is useful where, for example, the line of sight between vehicle 910 and oncoming vehicle 930 is obscured by a tree or other obstruction (e.g., other vehicles on the roadway, a building, a corner, a topography feature, etc.). The techniques illustrated and described with respect to step 515 of FIG. 5 and to step 410 of FIG. 4 may be applied for processing based, for example, on the inferred positions of headlamps at the front corners of the detected vehicle.

In an exemplary embodiment, oncoming vehicles 925, 930 broadcast their presence over wireless networks, as discussed herein. In some embodiments, oncoming vehicles 925, 930 include additional information along with location information in such broadcasts. For example, oncoming vehicles 925, 930 include an indication as to whether their headlights are activated and in what direction/speed the vehicles are traveling. Additionally, the broadcast may further include intensity information pertaining to the headlights or other lights emitted from oncoming vehicle 925, 930. Such information may be received directly by vehicle 910. In other embodiments, such information is broadcast from oncoming vehicle 925, 930 and stored at a database which is accessed by vehicle 910. In this way, oncoming vehicles 925, 930 broadcast information that assists system 900 with detecting incoming light and attenuating the viewing aperture (i.e., windshield) of vehicle 910. The techniques illustrated and described with respect to step 515 of FIG. 5 and to step 410 of FIG. 4 may be applied for processing based, for example, on the inferred positions of headlamps at the front corners of the detected vehicle.

In another exemplary embodiment of the present disclosure and with reference to FIG. 10, system 1000 includes user equipment device 1005. As illustrated, user equipment device 1005 includes a user interface having user selectable inputs with which a user can interact with system 1000. As illustrated, user equipment device 1005 can be used to specify the head position of one or more occupants of the vehicle. For example, system 1000 can be configured to automatically detect the occupant head position. In such an example, system 1000 uses information from one or more imaging or other photodetectors (e.g., imaging sensor 115, 215, 216, 915, 917) to determine the head and/or eye position of the driver of the vehicle. Other techniques for automatically determining the head position of one or more occupants of the vehicle are discussed herein, for example, with respect to FIGS. 2 and 5. Additionally, user equipment device 1005 can be used to calibrate various parameters of the system. For example, a calibrate function may be used to “teach” system 1000 as to where the head position of certain occupants of the vehicle are located. Additionally, user equipment device 1005 may be used to customize the location of the head position of one or more occupants of the vehicle.

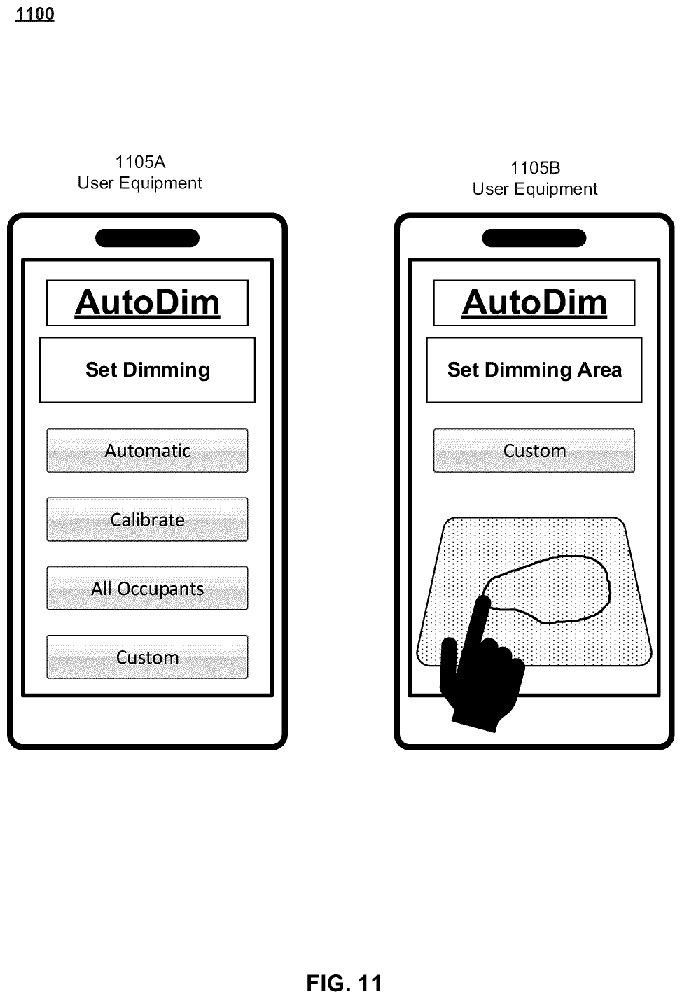

In another exemplary embodiment of the present disclosure and with reference to FIG. 11, system 1100 includes user equipment device 1105A. As illustrated, user equipment device 1105A includes a user interface with user selectable elements. For example, the user interface of user equipment 1105A can be used to configure system 1100 to operate in automatic mode. In such a mode, system 1100 automatically determines the placement of the occupants of the vehicle and determines the appropriate amount of attenuation to apply to the viewing aperture. In some embodiments, while in automatic mode, system 1100 only detects and attenuates light that is determined to be within the driver's line of sight.

Additionally, the user interface includes a user selectable option to configure system 1100 to attenuate light for all occupants of the vehicle. Additionally, the user interface of user equipment 1105A can be used to configure a custom setting. When selected, a user can specify the locations of the viewing aperture (i.e., the windshield of the vehicle) to attenuate. As illustrated, user equipment 1105B allows the user to specify the locations of the windshield to attenuate by, for example, using a finger to draw locations.

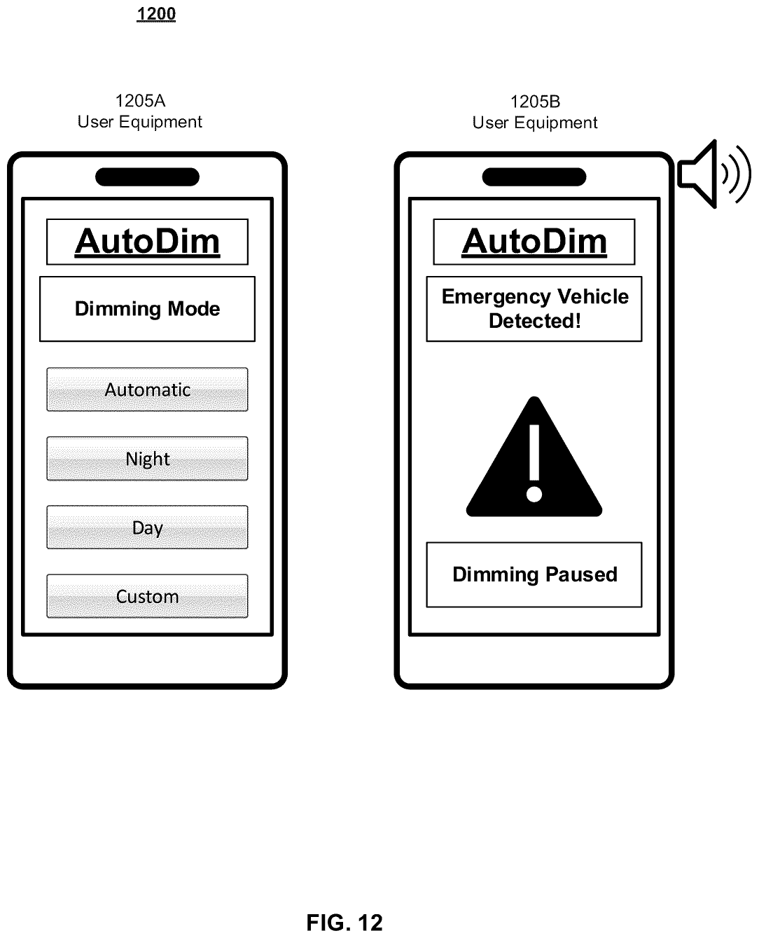

In another exemplary embodiment of the present disclosure and with reference to FIG. 12, user equipment 1205A can be used to configure a particular dimming mode of system 1200. As illustrated, user equipment 1205A includes user selectable inputs, for example, to configure system 1200 to operate in a nighttime or daytime driving mode. Additionally, user equipment 1205A can be used to configure system 1200 in an automatic mode. While in such a mode, system 1200 automatically determines certain parameters for detecting and attenuating light. For example, while in automatic mode, system 1200 may determine that it is to be configured in nighttime driving mode. While in such a mode, system 1200 configures certain threshold values and techniques that are optimized for nighttime driving. Various techniques for determining and implementing such thresholds are discussed herein, for example, at step 520 as discussed with respect to FIG. 5 and at step 615 as discussed with respect to FIG. 6.

In another embodiment, system 1200 may pause or suspend dynamic attenuation when the presence of an emergency vehicle is detected. In such an exemplary embodiment, system 1200 may display an alert on the user interface of, for example, user equipment device 1205B. The alert provides a notification to the user that an emergency vehicle is detected, and that dimming is paused. In addition to a visual alert, user equipment 1200 B may optionally emit an audio alert. For example, user equipment 1205B may emit a buzzer or other alert sound that alerts the user to the presence of an emergency vehicle. In other embodiments, the audio and/or visual alert may be displayed using one or more onboard systems of the vehicle. In such an exemplary embodiment, the audio and/or visual alert may be displayed on a vehicle's infotainment system, dash system, or other audio-visual system of the vehicle.

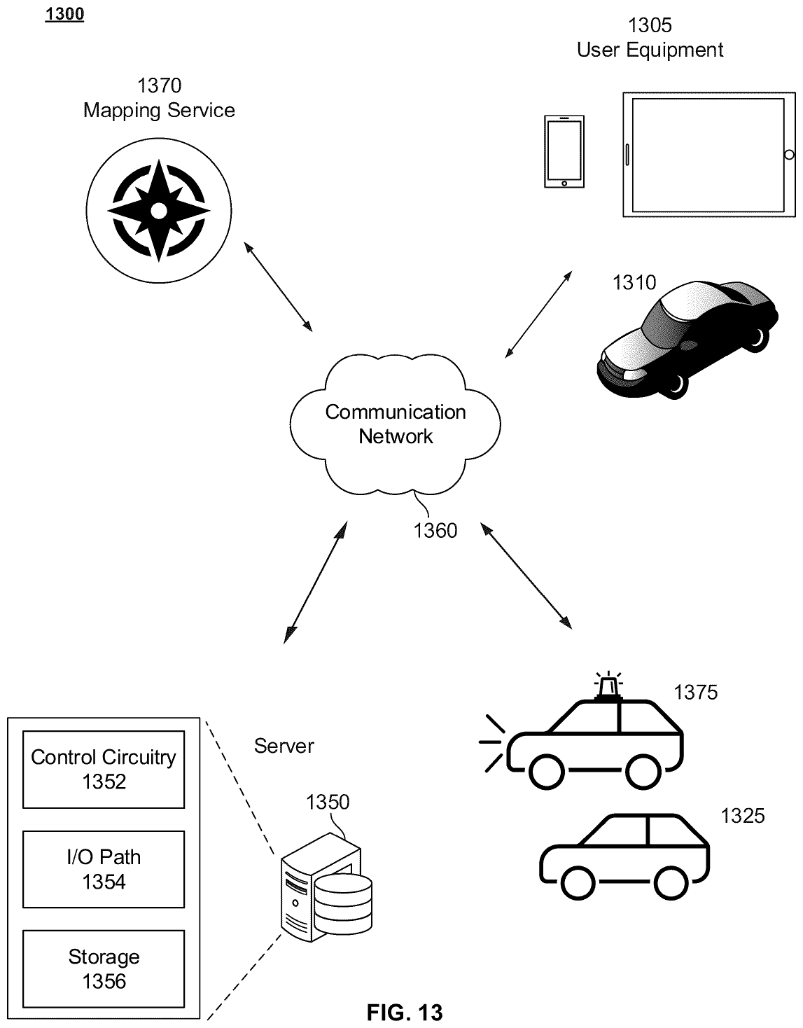

FIG. 13 illustrates an exemplary embodiment of the present disclosure where system 1300 includes and/or considers mapping information, for example, as discussed with respect to FIG. 9. System 1300 includes user equipment 1305, mapping service 1370, server 1350, which are able to communicate with one another using communication network 1360. In some embodiments, server 1350 includes control circuitry 1352, input/output (IO) path 1354, and storage 1356. FIG. 13 illustrates generalized embodiments of an illustrative device, e.g., user equipment 105, 1005, 1105A-B, 1205A-B, and vehicle 110, 210, 810, 910. For example, user equipment 1305 may be cellular telephone, a tablet, a laptop computer, a computer, a smartwatch (or other wearable technological device), a standalone navigation system, or a navigation system attached to, or built in, a vehicle (e.g., a vehicle navigation system or an infotainment system). In other embodiments, user equipment 1305 is navigational equipment installed or included in a vehicle. In some embodiments, server 1350 may include one or more circuit boards. In some embodiments, the circuit boards may include control circuitry (e.g., control circuitry 1352) and storage (e.g., RAM, ROM, Hard Disk, Removable Disk, etc.) (e.g., storage 1356). In some embodiments, circuit boards may include an input/output path (e.g., I/O Path 1354). In some embodiments, user equipment 1305 may receive content and data via input/output (hereinafter “I/O”) path 1354. I/O path 1354 may provide data (e.g., mapping data/information available over a local area network (LAN) or wide area network (WAN), and/or other content) to control circuitry 1352 and storage 1356. Control circuitry 1352 may be used to send and receive commands, requests, and other suitable data using I/O path 1354. I/O path 1354 may connect control circuitry 1352 to one or more communications paths (described herein). I/O functions may be provided by one or more of these communications paths but are shown as a single path in FIG. 13 to avoid overcomplicating the drawing.

Control circuitry 1352 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate units, for example, multiple of the same type of processing units (e.g., two Intel Core i7 processors) or multiple different processors (e.g., an Intel Core i5 processor and an Intel Core i7 processor). In some embodiments, control circuitry 1352 executes instructions for an application stored in memory (e.g., storage 1356). Specifically, control circuitry 1352 may be instructed by the application to perform the functions discussed herein. For example, the application may provide instructions to control circuitry 1352 to generate geographic information or other information related to the vehicle, oncoming vehicles, emergency vehicles, or other device described herein (including the viewing aperture and attenuation thereof). In some implementations, any action performed by control circuitry 1352 may be based on instructions received from the application.

In client server-based embodiments, control circuitry 1352 may include communications circuitry suitable for communicating with a user equipment (e.g., user equipment 1305), other vehicles, other user devices in other vehicles, or other networks or servers. The instructions for carrying out the functionality discussed herein may be stored on the server (e.g., server 1350). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry (e.g., I/O Path 1354). Such communications may involve the Internet or any other suitable communications networks or paths (e.g., I/O Path 1354). In addition, communications circuitry may include circuitry that enables peer-to-peer communication of user equipment devices (for example, as discussed with respect to FIG. 9), or communication of user equipment devices in locations remote from each other (described in more detail herein).

Memory may be an electronic storage device provided as storage 1356 that is part of control circuitry 1352. As referred to herein, the phrase “electronic storage device” or “storage device” should be understood to mean any device for storing electronic data, computer software, or firmware, such as random-access memory, read-only memory, hard drives, non-transitory computer readable medium, or any other suitable fixed or removable storage devices, and/or any combination of the same. Storage 1356 may be used to store various types of content, navigation data, and instructions for executing dynamic attenuation. Nonvolatile memory may also be used (e.g., to launch a boot-up routine and other instructions).

Control circuitry 1352 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1352 may also include scaler circuitry for upconverting and downconverting content into the preferred output format of the user equipment 1305. Circuitry 1352 may also include digital-to-analog converter circuitry and analog-to-digital converter circuitry for converting between digital and analog signals. The tuning and encoding circuitry may also be used to receive guidance data. The circuitry described herein, including for example, the tuning, video-generating, encoding, decoding, encrypting, decrypting, scaler, navigating, attenuating, and analog/digital circuitry, may be implemented using software running on one or more general purpose or specialized processors. If storage 1356 is provided as a separate device from user equipment 1305, the charging, mapping, and encoding circuitry may be associated with storage 1356.

A user may send instructions to control circuitry 1352 using a user input interface (e.g., user interface illustrated and described with user equipment 105, 1005, 1105A-B, 1205A-B) that is part of user equipment (e.g., user equipment 1305). User input interface may be any suitable user interface, such as a remote control, mouse, trackball, keypad, keyboard, touchscreen, touchpad, stylus input, joystick, voice recognition interface, or other user input interfaces. The user interface may be provided as a stand-alone device or integrated with other elements of each one of user equipment 1305 and system 1300. For example, user interface used with user equipment 105, 1005, 1105A-B, 1205A-B may be a touchscreen or touch-sensitive display. In such circumstances, user equipment 1305 may be integrated with or combined with such user interface.

Mapping service 1370 may be implemented using any suitable architecture. For example, mapping service 1370 may be a stand-alone application wholly implemented on user equipment 1305. In such an approach, instructions for the application are stored locally (e.g., mapping database located at server 1350 or mapping service 1370), and data for use by the application is downloaded on a periodic basis (e.g., from an out-of-band feed, from an Internet resource, or using another suitable approach). Control circuitry at user equipment (e.g., 105, 1005, 1105A-B, 1205A-B) retrieves instructions of the application from storage (e.g., a mapping database or storage 1356) and process the instructions to generate any of the displays discussed herein. Based on the processed instructions, control circuitry may determine what action to perform when input is received from input interface.

In an embodiment, user equipment 1305 communicates with controller 1325 to send and receive information related to oncoming vehicle 1325 or emergency vehicle 1375. Non limiting examples of information communicated to and from user equipment 1305 include attenuation information, environmental information, vehicle information, and route information. In embodiments where user equipment 1305 is implemented as a separate device, user equipment 1305 communicates with one or more vehicles (e.g., 110, 125, 210, 810, 825, 875, 910, 925, 930) over communication network 1360.

It is contemplated that some suitable steps or suitable descriptions of FIGS. 5-6 may be used with other suitable embodiments of this disclosure. In addition, some suitable steps and descriptions described in relation to FIGS. 5-6 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-3, 8-13 could be used to perform one or more of the steps in FIGS. 5-6.

The processes discussed herein are intended to be illustrative and not limiting. For instance, the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
detecting a light source;
determining, using control circuity, a location of the light source;
identifying a location of an occupant of a vehicle;
determining, using control circuity and based on the determined location of the light source and identified location of the occupant of the vehicle, a location at which light emanating from the detected light source intersects a viewing aperture of the vehicle, the viewing aperture comprising a polarizing layer; and
activating the polarizing layer based on the determined location at which the detected light intersects the viewing aperture.

2. The method of claim 1, wherein the viewing aperture comprises a windshield of a vehicle.

3. The method of claim 1, wherein the light source is a headlight of an oncoming vehicle.

4. The method of claim 1,
wherein the polarizing layer comprises a nanostructure comprising a plurality of horizontal rods and a plurality of vertical rods arranged in a grid pattern;
wherein the nanostructure comprises a plurality of pixels, each pixel of the plurality of pixels defined by the intersection of a horizontal rod of the plurality of horizontal rods and a vertical rod of the plurality of vertical rods; and
wherein activating the polarizing layer comprises applying a voltage to a plurality of pixels, wherein applying the voltage to the plurality of pixels causes the nanostructure to undergo a phase change at the location of the plurality of pixels.

5. The method of claim 4, wherein the phase change corresponds to the voltage applied to the plurality of pixels.

6. The method of claim 4, wherein the polarization layer comprising a plurality of zones, each zone comprising a subset of the plurality of pixels; and
wherein activating the polarizing layer further comprises applying the voltage to the plurality of pixels corresponding to each zone such that the phase change is uniform across the subset of the plurality of pixels.

7. The method of claim 6, wherein each size and shape of each zone of the plurality of zones is based on the location of the light source.

8. The method of claim 7, further comprising determining, using control circuity, a light intensity of the light emanating from the light source; wherein the size and shape of each zone of the plurality of zones is further based on the determined light intensity.

9. The method of claim 1 further comprising receiving, from a first imaging sensor, data related to the vehicle's surroundings;
wherein determining the location of the light source is based on the data received from the imaging sensor.

10. The method of claim 9 further comprising receiving, from a second imaging sensor, data related to an interior of the vehicle;
wherein identifying the location of an occupant of the vehicle is based on data received from the second imaging sensor.

11. The method of claim 10, wherein the first imaging sensor is oriented in a direction of travel of the vehicle, and wherein the second imaging sensor is oriented in a direction of the occupant of the vehicle.

12. The method of claim 9 further comprising:
determining a representation of the vehicle's surroundings based in part on the data received from the first imaging sensor; and
displaying the representation of the vehicle's surroundings to the occupant of the vehicle.

13. A viewing aperture comprising:
a polarizing layer comprising a nanostructure, wherein the nanostructure comprises:
a plurality of horizontal rods and a plurality of vertical rods arranged in a grid pattern; and
a plurality of pixels, each pixel of the plurality of pixels defined by the intersection of a horizontal rod of the plurality of horizontal rods and a vertical rod of the plurality of vertical rods; and
wherein in response to applying a voltage to the plurality of pixels, the nanostructure undergoes a phase change at the location of the plurality of pixels; and
wherein the location of the plurality of pixels is defined by the location at which light emanating from a light source to an occupant of a vehicle intersects the viewing aperture.

14. The viewing aperture of claim 13, wherein the voltage is applied to the plurality of pixels in response to detecting light that intersects the viewing aperture.

15. The viewing aperture of claim 14, wherein the viewing aperture is a windshield of the vehicle.

16. The viewing aperture of claim 15 further comprising an imaging sensor; wherein light is detected using the imaging sensor.

17. The viewing aperture of claim 13, wherein the voltage applied to the plurality of pixels corresponds to a light intensity of the light.

18. A system comprising:
a memory configured to store aperture attenuating information;
control circuitry configured to:
determine a location of a light source;
identify a location of an occupant of a vehicle;
determine, based on the determined location of the light source, a location at which light emanating from the light source intersects a viewing aperture of the vehicle, the viewing aperture comprising a polarizing layer; and
activate the polarizing layer based on the determined location at which the light intersects the viewing aperture; and
input/output circuitry configured to receive, from an imaging sensor, light data corresponding to light intersecting the viewing aperture.

19. The system of claim 18,
wherein the polarizing layer comprises a nanostructure comprising a plurality of horizontal rods and a plurality of vertical rods arranged in a grid pattern;
wherein the nanostructure comprises a plurality of pixels, each pixel of the plurality of pixels defined by the intersection of a horizontal rod of the plurality of horizontal rods and a vertical rod of the plurality of vertical rods; and
wherein activating the polarizing layer comprises applying a voltage to a subset of the plurality of pixels, wherein applying the voltage to the subset of the plurality of pixels causes the nanostructure to undergo a phase change at the location of the subset of the plurality of pixels.

20. The system of claim 19, wherein the phase change corresponds to the voltage applied to the plurality of pixels.
